(19) United States
(12) Patent Application Publication
(10) Pub. No.: US 2018/0179995 A1
(43) Pub. Date: Jun. 28, 2018

(54) INTERNAL COMBUSITION ENGINE CONTROL APPARATUS

(71) Applicant: DENSO CORPORATION, Kariya-city (JP)

(72) Inventors: Takamasa ITO, Kariya-city (JP); Youhei MORIMOTO, Kariya-city (JP); Shinichiro KAWAKITA, Kariya-city (JP)

(73) Assignee: DENSO CORPORATION, Kariya-city (JP)

(21) Appl. No.: 15/847,170

(22) Filed: Dec. 19, 2017

(30) Foreign Application Priority Data
Dec. 23, 2016 (JP) 2016-250211
Apr. 3, 2017 (JP) 2017-073662

(51) Int. Cl. F02M 25/12; F02D 41/00; F02D 41/40; F02M 25/022

(52) U.S. Cl. CPC F02M 25/12; F02D 41/0025; F02D 35/025; F02M 25/0225; F02D 2200/0611; F02D 41/403

(57) ABSTRACT

An internal combustion engine control apparatus includes a fuel injection apparatus injecting fuel into a combustion chamber a plurality of times during a single cycle, and controls an internal combustion engine that performs compression combustion. The internal combustion engine control apparatus includes an injection command unit and an injection specification determining unit. The injection command unit commands the fuel injection apparatus to perform: a main injection for a main combustion that generates torque; and a preceding injection that is performed at a stage before the main injection. The injection specification determining unit determines a penetration force of a spray produced by the preceding injection or an injection direction of the preceding injection, such that a range of reach of the spray produced by the preceding injection is closer to a nozzle hole of the fuel injection apparatus than a range of reach of a spray produced by the main injection.

### CROSS-REFERENCE TO RELATED APPLICATIONS

This application is based on and claims the benefit of priority from Japanese Patent Application Nos. 2016-250211, filed Dec. 23, 2016, and 2017-073662, filed Apr. 3, 2017. The entire disclosures of the above applications are incorporated herein by reference.

### BACKGROUND

### Technical Field

The present disclosure relates to an internal combustion engine control apparatus. The present disclosure also relates to an internal combustion engine control system that controls combustion in an internal combustion engine.

### Related Art

An internal combustion engine that includes a fuel injection apparatus and performs compression ignition is known. The fuel injection apparatus injects fuel into a combustion chamber a plurality of times during a single cycle. In Japanese Patent Publication No. 3911912, a first fuel injection for initial combustion speed control is performed at an intake stroke. Then, an ignition trigger means, such as a spark plug, generates an ignition trigger. At a subsequent compression stroke, a second fuel injection for torque control is performed. A spray produced by the first fuel injection is diffused throughout the combustion chamber and forms a homogeneous air-fuel mixture together with intake air. Then, the air-fuel mixture is activated by compression and the ignition trigger, and generates radicals.

In Japanese Patent Publication No. 3911912, the spray produced by the first fuel injection is diffused throughout the combustion chamber and forms an even air-fuel mixture together with the intake air. Thus, premixing may progress at a location away from a nozzle hole of the fuel injection apparatus and ignition may occur. Due to this, sudden combustion may occur, thereby making it difficult to implement a clean diffusive combustion. Combustion does not occur all at once in the clean diffusive combustion. In other words, fine droplets are vaporized to repeatedly auto-ignite and combust, and the combustion spreads to adjacent droplets, thereby resulting in a flame produced by a cluster of droplets. When the clean diffusive combustion is not implemented, there is a concern that vibration may be generated, and NOx may increase.

In relation to combustion control of an internal combustion engine, a technology for improving auto-ignitability of fuel is known. For example, Japanese Patent Publication No. 5906982 discloses a compression auto-ignition engine that includes a means for supplying ozone into a combustion chamber. Due to decomposition of the ozone, oxygen (O) radicals are produced. Auto-ignition of fuel during homogenous charge compression ignition (HCCI) is thereby promoted. In addition, a timing at which the ozone is supplied is adjusted based on a load of the engine. That is, the timing at which the ozone is supplied is adjusted by an injection timing of the fuel being delayed when the engine load is high.

As also described in Japanese Patent Publication No. 5906982, ozone decomposes when an internal temperature of the combustion chamber is about 500 K to 600 K. The O radicals are then generated. Hereafter, the temperature unit [K] refers to kelvin.

Radicals are unstable active substances, most of which dissipate in a short amount of time after being generated. For example, a time constant of the O radicals is several tens of microseconds. It is thought that the O radicals decrease to an order of one-several thousandth to one-several ten thousandth or less before even the elapse of a single millisecond after being generated.

In addition, the temperature near a compression end (that is, a top dead center) in a high compression ratio engine is about 800 K to 900 K, which exceeds the decomposition temperature of ozone. Therefore, when fuel is injected near the compression end of the high compression ratio engine, it becomes difficult for 0 radicals to be supplied to the fuel by ozone being supplied. Therefore, in the conventional technology in Japanese Patent Publication No. 5906982, a problem occurs in that ignitability of fuel cannot be improved when the internal temperature of the combustion chamber is high.

### SUMMARY

It is thus desired to provide an internal combustion engine control apparatus that is capable of preventing sudden combustion while ensuring ignitability in compression ignition, and actualizing a stable diffusive combustion. It is also desired to provide an internal combustion engine control system that improves ignitability of fuel when an internal temperature of a combustion chamber is high, in an internal combustion engine that uses an auto-ignition combustion method.

A first exemplary embodiment of the present disclosure provides an internal combustion engine control apparatus that includes an injection command unit and an injection specification determining unit. The injection command unit commands a fuel injection apparatus to perform a main injection for a main combustion that generates torque and a preceding injection that is performed at a stage before the main injection. The injection specification determining unit determines a penetration force of a spray produced by the preceding injection or an injection direction of the preceding injection, such that a range of reach of the spray produced by the preceding injection is closer to a nozzle hole of the fuel injection apparatus than a range of reach of a spray produced by the main injection.

According to this configuration, the spray produced by the preceding injection is prevented from being diffused throughout the combustion chamber. Radicals generated by a low-temperature oxidation reaction of the spray are locally generated in a location near the nozzle hole. Therefore, a high concentration of radicals can be supplied to the spray produced by the main injection at the location near the nozzle hole. Consequently, sudden combustion can be prevented while ensuring ignitability in compression ignition. A stable diffusive combustion can be obtained. As a result, generation of vibrations and increase in NOx can be suppressed. Furthermore, cooling loss is reduced because combustion along a wall of the combustion chamber is suppressed.

Here, multi-stage injection performed in diesel engines will be described. Fuel injection may be performed twice in diesel engines, as well. However, light oil is highly reactive, and therefore, immediately undergoes a combustion reaction. Supplying intermediate products, such as radicals, to the second injection becomes difficult. In diesel engines, the multi-stage injection is performed for the purpose of increasing the temperature inside a cylinder through combustion of the fuel of the first injection.

In addition, in diesel engines, changing injection location between the first and second injections is considered effective for enabling efficient use of oxygen inside the combustion chamber. To this end, for example, swirl flow is used. In this regard, in the present disclosure, passing the spray produced by the main injection through the range of reach of the preceding spray is effective for supplying the radicals to the spray produced by the main injection.

In the present specification, the “internal combustion engine that performs compression ignition” includes an internal combustion engine that does not include a spark plug and performs only compression ignition, and an internal combustion engine that includes a spark plug and switches ignition between a spark ignition mode and a compression ignition mode.

A second exemplary embodiment of the present disclosure provides an internal combustion engine control system that controls operation of an internal combustion engine in a combustion mode in which fuel contained in air is auto-ignited and combusted. The internal combustion engine control system includes at least one added substance supply apparatus and a supply control unit. The added substance supply apparatus supplies an added substance that generates radicals in an intake passage or a combustion chamber. The supply control unit controls a supply amount of the added substance. In addition, the added substance includes at least a substance that generates radicals at a temperature equal to or higher than 700 K.

Here, “generating radicals at a temperature equal to or higher than 700 K” means that an amount of radicals that is realistically effective in the light of common technical knowledge of this technical field can be generated. That is, in general, decomposition of a chemical substance is understood to be a phenomenon of primary delay response in which chemical equilibrium shifts towards a decomposition side after the start of reaction and converges after an infinite amount of time. In other words, decomposition is not 100% completed after a finite amount of time from the start of reaction. Rather, strictly speaking, a miniscule amount of the substance remains in an undecomposed state. For example, ozone disclosed in Japanese Patent Publication No. 5906982 can be considered to be substantially decomposed at 700 K, and most of the generated O radicals can be considered to immediately dissipate. However, a miniscule amount of 0 radicals are present over the time of a combustion cycle order of the internal combustion engine.

However, such a miniscule amount of 0 radicals cannot be considered realistically effective in achieving an effect of improved ignitability, in light of common technical knowledge. Therefore, even should the amount of generated O radicals not strictly be zero, this level of O radical generation is excluded from the interpretation of “generating radicals.”

That is, the identifying matter of “generating radicals at a temperature equal to or higher than 700 K,” in effect, excludes the conventional technology in Japanese Patent Publication No. 5906982 in which only ozone is supplied into the combustion chamber.

In addition, “generating radicals at a temperature equal to or higher than 700 K” does not mean that radicals can be generated at all high-temperature ranges equal to or higher than 700 K, such as several thousand K. This requirement is interpreted as being met when generation of radicals by an added substance can be obtained at a temperature range of 800 K to 900 K, for example. It is, of course, obvious that temperature ranges that exceed realistic internal temperatures of a combustion chamber, in light of common technical knowledge regarding internal combustion engines, are not required to be taken into consideration.

In the present disclosure, an added substance that generates radicals in the intake passage or the combustion chamber at a temperature equal to or higher than 700 K is supplied. As a result, for example, in the diffusive combustion method for combusting gasoline, an effective amount of radicals can be generated even when the combustion chamber internal temperature during fuel injection near a top dead center is 800 K to 900 K, and ignitability can be improved.

In the internal combustion engine control system, as a specific added substance supply apparatus, a hydrogen peroxide supply apparatus is preferably provided. The hydrogen peroxide supply apparatus supplies hydrogen peroxide that generates hydroxyl (OH) radicals in the intake passage or the combustion chamber at a temperature equal to or higher than 700 K. Moreover, a configuration in which both hydrogen peroxide and ozone are supplied is also possible.

As the hydrogen peroxide supply apparatus, for example, a technology disclosed in Japanese Patent Publication No. 4103525 in which water is irradiated with ultrasonic waves and changed to hydrogen peroxide can be used.

### BRIEF DESCRIPTION OF THE DRAWINGS

In the accompanying drawings:

FIG. 1 is a schematic diagram for explaining an internal combustion engine to which an ECU according to a first embodiment of the present disclosure is applied;

FIG. 2 is a time chart of injection amount and injection timing of an injector in FIG. 1;

FIG. 3 is an enlarged cross-sectional view of section III in FIG. 1, schematically showing a range of reach of a spray during a preceding injection;

FIG. 4 is an enlarged cross-sectional view of section IV in FIG. 1, schematically showing a range of reach of a spray during a main injection;

FIG. 5 is a block diagram for explaining functional units provided in the ECU in FIG. 1;

FIG. 6 is a time chart of when a preceding injection proportion is set to be greater than that in FIG. 2;

FIG. 7 is a time chart of when the preceding injection proportion is set to be smaller than that in FIG. 2;

FIG. 8 is a flowchart for explaining processes performed by the ECU in FIG. 1;

FIG. 9 is a schematic diagram for explaining an internal combustion engine to which an ECU according to a second embodiment of the present disclosure is applied;

FIG. 10 is a cross-sectional view of the internal combustion engine controlled by the ECU in FIG. 9, schematically showing a range of reach of a spray during a preceding injection;

FIG. 11 is a cross-sectional view of the internal combustion engine controlled by the ECU in FIG. 9, schematically showing a range of reach of a spray during a main injection;

FIG. 12 is a schematic diagram for explaining an internal combustion engine to which an ECU according to a third embodiment of the present disclosure is applied;

FIG. 13 is a cross-sectional view of the internal combustion engine controlled by the ECU in FIG. 12, schematically showing a range of reach of a spray during a preceding injection;

FIG. 14 is a cross-sectional view of the internal combustion engine controlled by the ECU in FIG. 9, schematically showing a range of reach of a spray during a main injection;

FIG. 15 is a block diagram for explaining functional units provided in an ECU according to a fourth embodiment of the present disclosure;

FIG. 16 is a time chart of injection amount and injection timing of an injector in FIG. 15;

FIG. 17 is a flowchart for explaining processes performed by the ECU in FIG. 15;

FIG. 18 is a block diagram for explaining functional units provided in an ECU according to a fifth embodiment of the present disclosure;

FIG. 19 is a block diagram for explaining functional units provided in an ECU according to a sixth embodiment of the present disclosure;

FIG. 20 is a time chart of injection amount and injection timing of an injector in FIG. 19;

FIG. 21 is a configuration diagram of an internal combustion engine control system according to a seventh embodiment;

FIG. 22 is a diagram of a setup state of a combustion chamber internal temperature sensor;

FIG. 23 is a flowchart of supply control according to the seventh and eighth embodiments;

FIG. 24A is a map for determining a hydrogen peroxide supply amount based on the combustion chamber internal temperature, and FIG. 24B is a map for determining the hydrogen peroxide supply amount based on an operating load;

FIG. 25 is a diagram of a comparison of decomposition characteristics between ozone and hydrogen peroxide;

FIG. 26 is a characteristics diagram of a relationship between crank angle and the combustion chamber internal temperature;

FIG. 27 is a configuration diagram of an internal combustion engine control system according to the eighth embodiment;

FIG. 28 is a configuration diagram of an internal combustion engine control system according to a ninth embodiment;

FIG. 29 is a flowchart of supply control according to the ninth embodiment;

FIG. 30 is a map for determining the hydrogen peroxide supply amount based on an amount of unburned HC and SOOT emissions;

FIG. 31 is a configuration diagram of an internal combustion engine control system according to a tenth embodiment;

FIG. 32 is a flowchart of supply control according to the tenth embodiment;

FIG. 33A is a map for determining a hydrogen peroxide or ozone supply amount based on the combustion chamber internal temperature, FIG. 33B is a map for determining the hydrogen peroxide or ozone supply amount based the operating load, and FIG. 33C is a map for determining the hydrogen peroxide or ozone supply amount based the amount of unburned HC and SOOT emissions;

FIG. 34A is a map for determining a hydrogen peroxide and ozone supply amount based on the combustion chamber internal temperature, and FIG. 34B is a map for determining a ratio of (hydrogen peroxide supply amount/ozone supply amount) based on the combustion chamber internal temperature;

FIG. 35 is a diagram of changes in fuel injection timing based on combustion mode; and

FIG. 36A is a flowchart of supply control in each mode, and FIG. 36B is a flowchart of supply control during a mode transition period.

### DESCRIPTION OF THE EMBODIMENTS

### 1. First to Sixth Embodiments

A plurality of embodiments of the present disclosure will hereinafter be described with reference to the drawings. Configurations among the embodiments that are essentially identical are given the same reference numbers. Descriptions thereof are omitted.

### First Embodiment

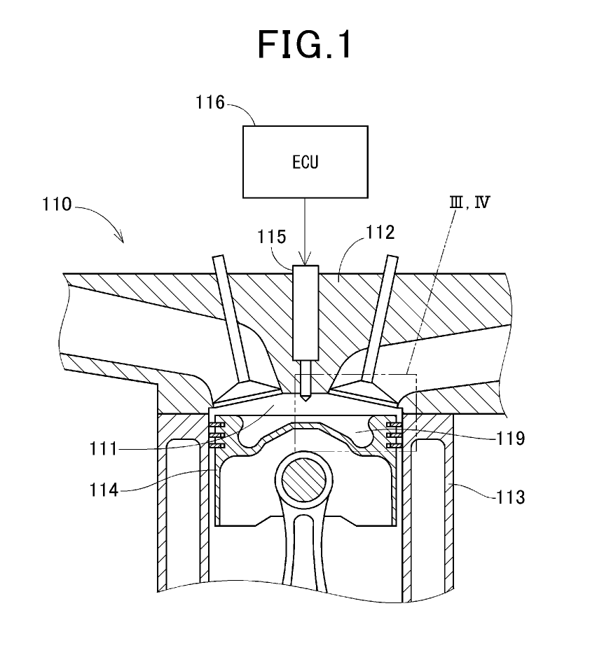

An electronic control unit (ECU) according to a first embodiment of the present disclosure serves as an internal combustion engine control apparatus. The ECU controls an internal combustion engine shown in FIG. 1.

### (Internal Combustion Engine)

An internal combustion engine 110 shown in FIG. 1 uses gasoline, for example, as fuel and performs compression ignition. Compression ignition is an ignition method that takes advantage of auto-ignition of fuel that is injected into compressed, heated air inside a combustion chamber 111. The combustion that occurs at this time is diffusive combustion. In diffusive combustion, fine droplets in a spray are vaporized. Individual droplets repeatedly auto-ignite and combust. The combustion spreads to adjacent droplets, thereby resulting in a flame produced by a cluster of droplets. The injection of the fuel is performed by a direct-injection injector 115. The injector 15 directly injects the fuel into the combustion chamber 111 that is partitioned between a cylinder head 112 and a piston 114 provided inside a cylinder 113.

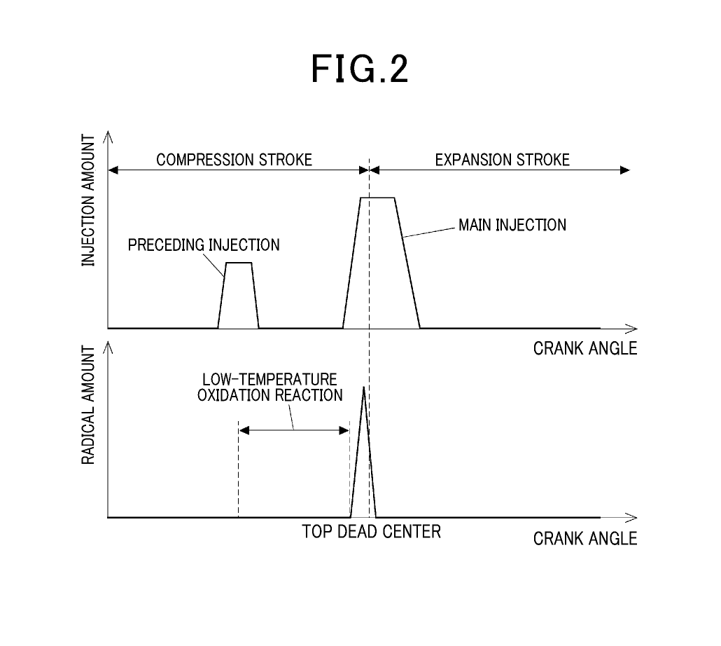

The injector 115 operates under the command of an ECU 116. The injector 115 injects the fuel at least twice during a single cycle. The single cycle includes an intake stroke, a compression stroke, an expansion (combustion) stroke, and an exhaust stroke. Fuel injection by the injector 115 includes a main injection and a preceding injection. The main injection is performed for a main combustion that generates torque. The preceding injection is performed at a stage before the main injection. According to the present embodiment, as shown in FIG. 2, the main injection is performed once during a period from the compression stroke to the expansion stroke. In addition, the preceding injection is performed once before the main injection, at the compression stroke. According to the first embodiment, a preceding injection timing and a main injection timing are fixed for each cycle.

The spray produced by the preceding injection undergoes a low-temperature oxidation reaction before the main injection is performed. Radicals are then generated at a timing coinciding with the main injection timing. The radicals are highly reactive intermediate products and are also referred to as cool flames. The radicals are capable of improving ignitability of fuel. The radicals are present in high concentration for only a limited period, due to chemical instability thereof. For example, the radicals that are generated from a spray that is injected at the intake stroke are likely to dissipate by the end of the compression stroke. Taking this point into consideration, the preceding injection timing according to the first embodiment is set to be at the compression stroke, such that a radical generation timing coincides with the main injection timing.

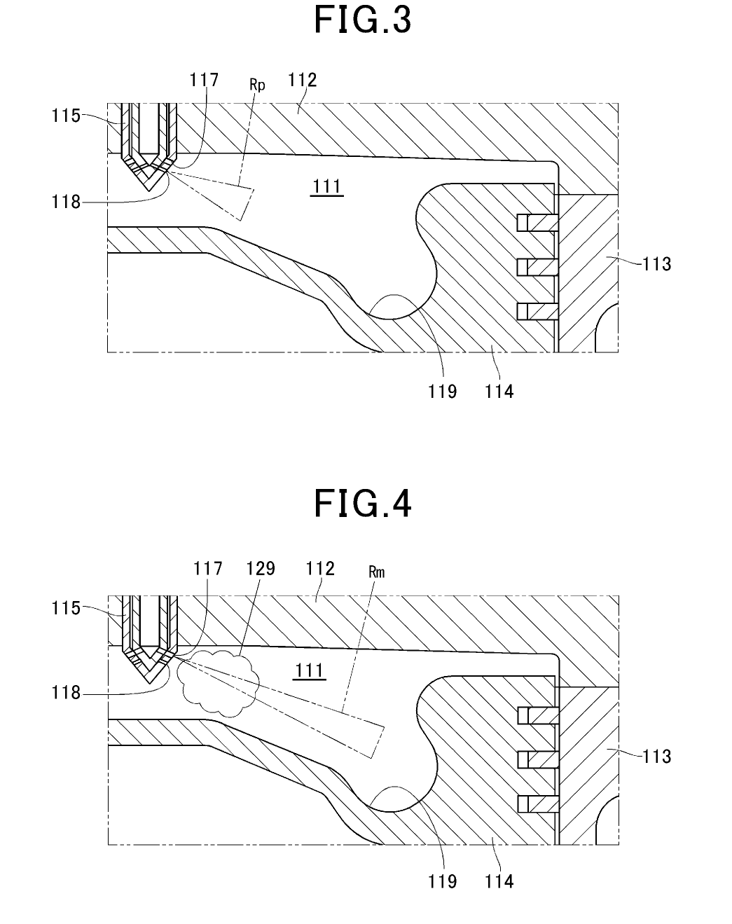

According to the first embodiment, as shown in FIGS. 3 and 4, the injector 115 has two types of nozzle holes 117 and 118. As shown in FIG. 3, the nozzle hole 118 is a hole from which the fuel is injected when the preceding injection is performed. As shown in FIG. 4, the nozzle hole 117 is a hole from which the fuel is injected when the main injection is performed. Injection directions of both nozzle holes 117 and 118 face a piston cavity 119. In addition, the nozzle hole 118 has a smaller inner diameter (hereafter, nozzle hole diameter) than the nozzle hole 117. A smaller nozzle hole diameter indicates a shorter spray reach distance x. The spray reach distance x is expressed by an expression (1), below.

$$\begin{matrix}[ Formula 1 ] & \\ x = \sqrt{\frac{{ρ}_{f}}{{ρ}_{a}}} \sqrt{\frac{{d}_{n} {w}_{0}}{tan θ}} \sqrt{t} & ( 1 )\end{matrix}$$

In the expression (1), ρf denotes fuel density, pa denotes air density, do denotes nozzle hole diameter, θ denotes spreading angle of a spray, and t denotes injection time. W₀ denotes speed of a spray and is proportional to a square root of injection pressure. Therefore, penetration force of the spray produced by the preceding injection (hereafter, preceding spray) is less than the penetration force of the spray produced by the main injection (hereafter, main spray). For example, JP-A-2013-119836 discloses an injector that includes two types of nozzle holes in which one nozzle hole has a smaller nozzle hole diameter than the other. Therefore, a description of a detailed configuration thereof is omitted.

### (Functions of the ECU)

As shown in FIG. 5, the ECU 116 includes an information acquiring unit 121, an injection amount determining unit 122, a penetration force determining unit 123, and an injection command unit 124. The penetration force determining unit 123 configures an injection specification determining unit that determines injection specification.

The information acquiring unit 121 acquires detection values of a temperature sensor 125 and a fuel property sensor 126, and a target load of the internal combustion engine 110 that is calculated by another control unit. For example, the temperature sensor 125 is provided in the cylinder head 112 and detects a temperature of the combustion chamber 111 (hereafter, combustion chamber temperature). The temperature sensor 125 is set so as to not protrude into the combustion chamber 111 or to protrude by a miniscule amount, to prevent interference with the spray. As a result, the temperature sensor 125 can be prevented from becoming high in temperature and causing ignition. For example, the fuel property sensor 126 is provided in a fuel tank or along a fuel supply path. The fuel property sensor 126 detects a property of the fuel, such as an octane number.

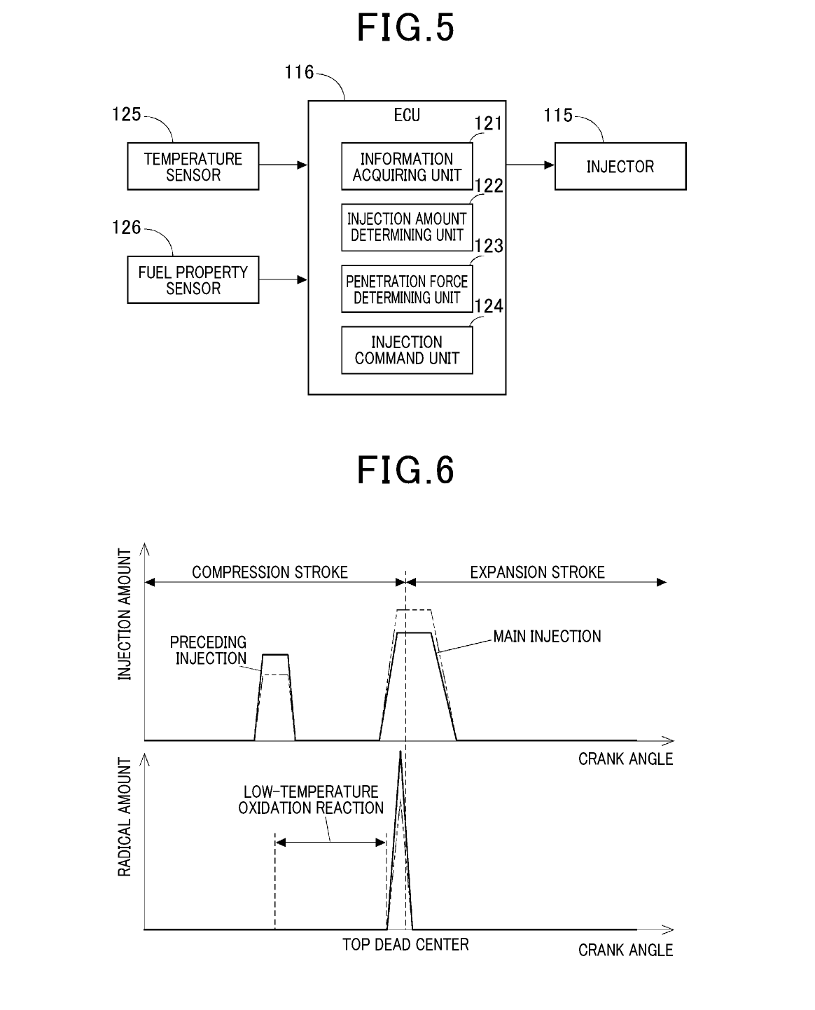

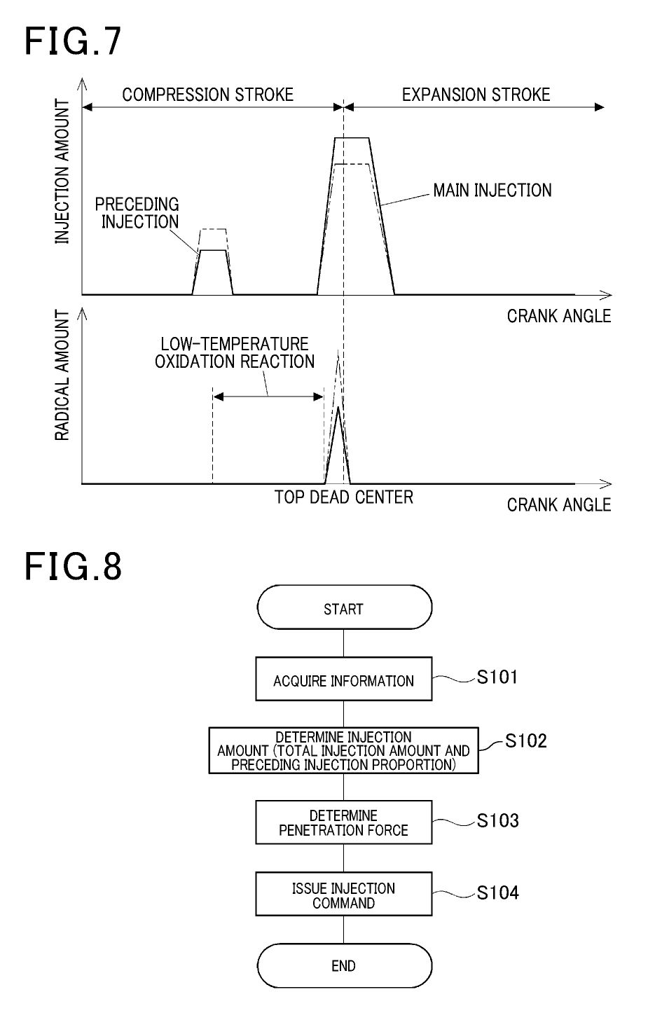

The injection amount determining unit 122 first determines a total injection amount based on the target load. The total injection amount is a sum of the fuel injection amount of the main injection and the fuel injection amount of the preceding injection. Next, the injection amount determining unit 122 determines a proportion of the injection amount of the preceding injection (hereafter, preceding injection proportion) in relation to the total injection amount. Specifically, as shown in FIG. 6, the injection amount determining unit 122 increases the preceding injection proportion as the target load decreases (that is, as compression ignition becomes more difficult to perform). As shown in FIG. 7, the injection amount determining unit 122 reduces the preceding injection proportion as the target load increases (that is, as compression ignition becomes easier to perform). As a result, the amount of radicals (hereafter, radical amount) generated by the low-temperature oxidation reaction of the preceding spray becomes relatively large as shown in FIG. 6, when compression ignition is difficult. In addition, the radical amount becomes relatively small as shown in FIG. 7, when compression ignition is easy, and the main injection amount becomes relatively large.

The penetration force determining unit 123 determines the penetration force of the preceding spray such that a range of reach of the preceding spray (hereafter, preceding spray range) is closer to the nozzle hole 117 than a range of reach of the main spray (hereafter, main spray range). That is, the penetration force determining unit 123 controls a location in which the radicals are generated by the preceding spray, based on the penetration force. Specifically, during the preceding injection before the main injection for the main combustion, the penetration force determining unit 123 determines that the fuel is sprayed from the nozzle hole 18 that has a smaller nozzle hole diameter than the nozzle hole 117 used for the main injection. That is, for the preceding injection, the nozzle hole 18 that has a relatively small nozzle hole diameter is selected. For the main injection, the nozzle hole 117 that has a relatively large nozzle hole diameter is selected. As a result, a preceding spray range Rp shown in FIG. 3 is closer to the nozzle hole 117 than a main spray range Rm shown in FIG. 4.

The injection command unit 124 includes a drive circuit that drives the injector 115, and the like. The injection command unit 124 commands the injector 115 to perform the main injection and the preceding injection at the determined injection amount and the penetration force, at predetermined injection timings.

### (Processes by the ECU)

The ECU 116 performs processes shown in FIG. 8.

First, at step S101, the information acquiring unit 121 acquires the combustion chamber temperature, the octane number of the fuel, and the target load of the internal combustion engine 110.

At step S102 following step S101, the injection amount determining unit 122 determines the total injection amount and the preceding injection proportion based on the target load. The preceding injection proportion is set to be greater as the target load decreases. The preceding injection proportion is set to be smaller as the target load increases.

At step S103 following step S102, the penetration force determining unit 123 determines that, during the preceding injection, the fuel is to be injected from the nozzle hole 118 that has a smaller nozzle hole diameter than the nozzle hole 117 used for the main injection, such that the preceding spray range is closer to the nozzle hole 117 than the main spray range.

At step S104 following step S103, the injection command unit 124 commands the injector 115 to perform the main injection and the preceding injection at the injection amount determined at step S102 and the penetration force determined at step S103, at the predetermined injection timings.

After step S104, the process leaves the routine in FIG. 5.

### (Effects)

As described above, according to the first embodiment, the ECU 116 includes the injection command unit 124 and the penetration force determining unit 123. The injection command unit 124 commands the injector 115 to perform the main injection and the preceding injection. The penetration force determining unit 123 determines the penetration force of the preceding spray such that the preceding spray range is closer to the nozzle hole 117 of the injector 115 than the main spray range.

According to this configuration, the preceding spray can be prevented from being diffused throughout the combustion chamber 111. As shown in FIG. 4, an air-fuel mixture 129 that contains the radicals generated by the low-temperature oxidation reaction of the preceding spray is locally formed in a location near the nozzle hole 117. Therefore, a high concentration of radicals can be supplied to the main spray at the location near the nozzle hole 117. Consequently, sudden combustion can be prevented while ensuring ignitability in compression ignition. A stable diffusive combustion can be obtained. As a result, generation of vibration and increase in NOx can be suppressed. In addition, because combustion along the wall of the combustion chamber 111 is suppressed, cooling loss is reduced.

Here, the radicals are present in high concentration for only a limited period, due to the chemical instability thereof. For example, the radicals that are generated from a spray that is injected at the intake stroke are likely to dissipate by the end of the compression stroke. In addition, the spray that is injected at the intake stroke is diffused throughout the combustion chamber 111 due to the flow of intake air. In this regard, according to the first embodiment, the preceding injection is performed at the compression stroke. Therefore, the generation timing of the radicals can be set so as to coincide with the main injection timing. In addition, the radicals can be locally disposed near the nozzle hole 117.

In addition, according to the first embodiment, the nozzle hole diameter of the nozzle hole 118 used for the preceding injection is smaller than the nozzle hole diameter of the nozzle hole 117 used for the main injection. As a result, the penetration force of the preceding spray is less than the penetration force of the main spray. The preceding spray range is closer to the nozzle hole 117 of the injector 115 than the main spray range.

As a result, the radicals generated by the low-temperature oxidation reaction of the preceding spray are locally generated in a location near the nozzle hole 117.

Furthermore, according to the first embodiment, the information acquiring unit 121 is provided. The information acquiring unit 121 acquires information related to the load of the internal combustion engine 110. The injection amount determining unit 122 sets the preceding injection proportion to be greater as the load of the internal combustion engine 110 decreases. The injection amount determining unit 122 sets the preceding injection proportion to be smaller as the load of the internal combustion engine 110 increases.

As a result, the radical amount becomes relatively large under conditions in which compression ignition is difficult to perform. Ignitability is improved. In addition, the radical amount becomes relatively small under conditions in which the compression ignition is easy to perform. The main injection amount becomes relatively large. Therefore, a degree of constant-volume combustion improves and thermal efficiency increases.

### Second Embodiment

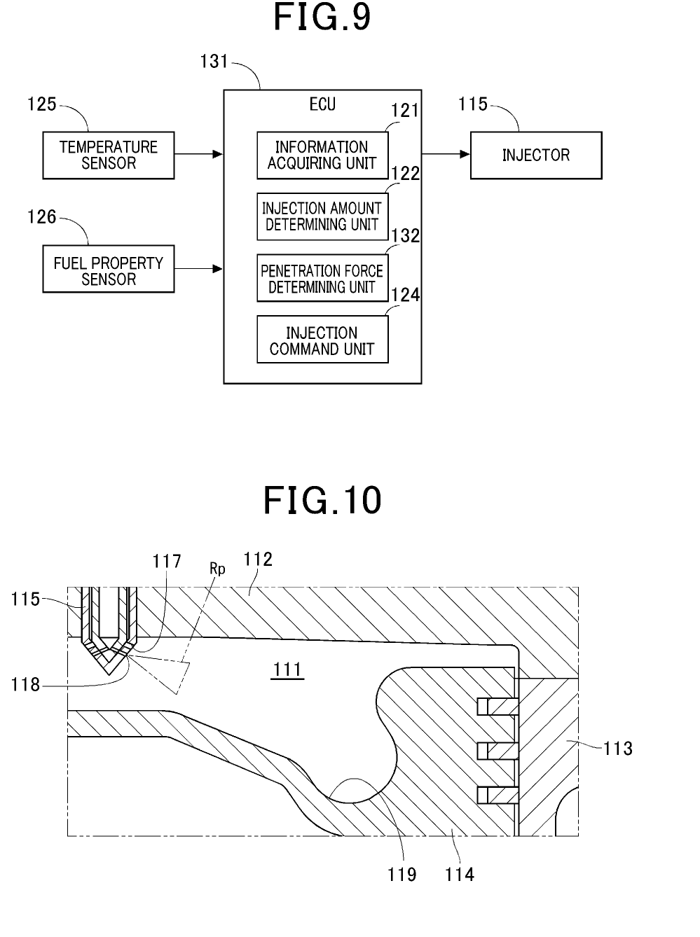

According to a second embodiment of the present disclosure, a penetration force determining unit 132 of an ECU 131 shown in FIG. 9 determines the penetration force of the preceding spray such than the preceding spray range is closer to the nozzle hole 117 of the injector 115 than the main spray range. That is, the penetration force determining unit 132 determines that, when the preceding injection before the main injection for the main combustion is performed, the fuel is injected with a smaller nozzle hole diameter and lower injection pressure than that of the main injection.

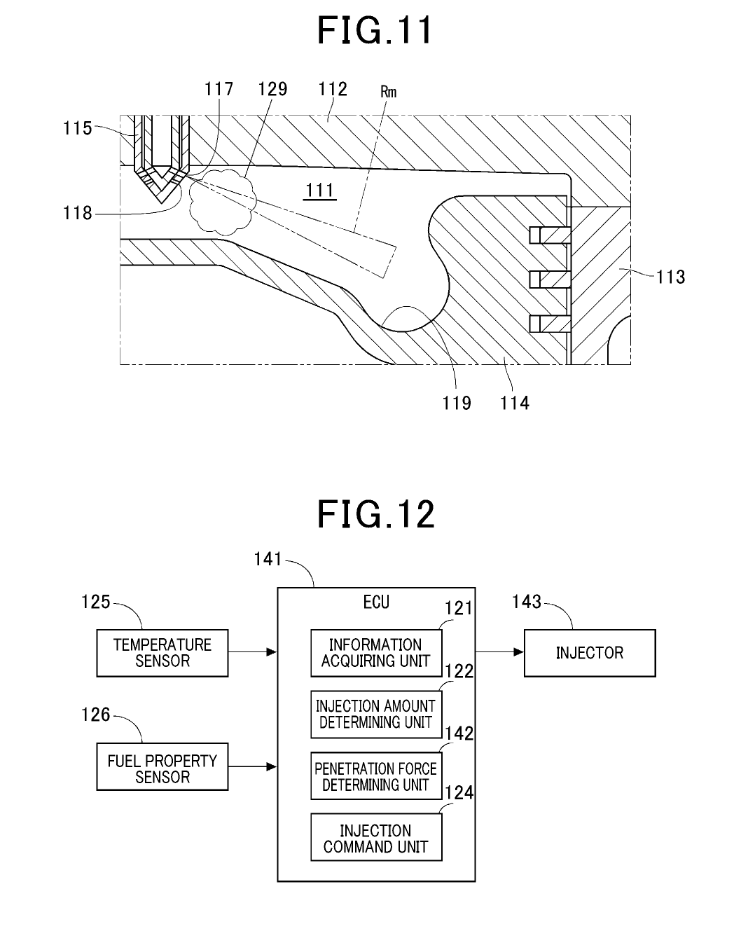

The nozzle hole diameter of the nozzle hole 118 used for the preceding injection is smaller than the nozzle hole diameter of the nozzle hole 117 used for the main injection. In addition, the injection pressure of the preceding injection is lower than the injection pressure of the main injection. The smaller injection hole diameter and the lower injection pressure indicate a shorter spray reach distance x. The spray reach distance x is expressed by the expression (1), above. In the expression (1), W₀ denotes the speed of the spray and is proportional to the square root of the injection pressure. Therefore, the penetration force of the preceding spray is less than the penetration force of the main spray. The preceding spray range Rp shown in FIG. 10 is closer to the nozzle hole 117 of the injector 115 than the main spray range Rm shown in FIG. 11. For example, JP-A-2009-545701 discloses an injector in which the injection pressure is variable. Therefore, a description of a detailed configuration thereof is omitted.

Even when the injection pressure of the preceding injection is lower than the injection pressure of the main injection in this manner, the preceding spray range can be set closer to the nozzle hole 117 of the injector 115 than the main spray range. Consequently, in a manner similar to that according to the first embodiment, sudden combustion can be prevented while ensuring ignitability in compression ignition. A stable diffusive combustion can be obtained.

In addition, both the injection hole diameter and the injection pressure of the preceding injection are reduced. As a result, the preceding spray range can be set closer to the nozzle hole 117 than in cases in which only either of the injection diameter and the injection pressure is reduced.

### Third Embodiment

According to a third embodiment of the present disclosure, a penetration force determining unit 142 of an ECU 141 shown in FIG. 12 determines an injection direction of the preceding spray such that the preceding spray range is closer to a nozzle hole 144 of an injector 148 than the main spray range. That is, the penetration force determining unit 142 determines that, when the preceding injection before the main injection for the main combustion is performed, the fuel is injected such that the injection direction is further towards a partition wall of the combustion chamber than that for the main injection.

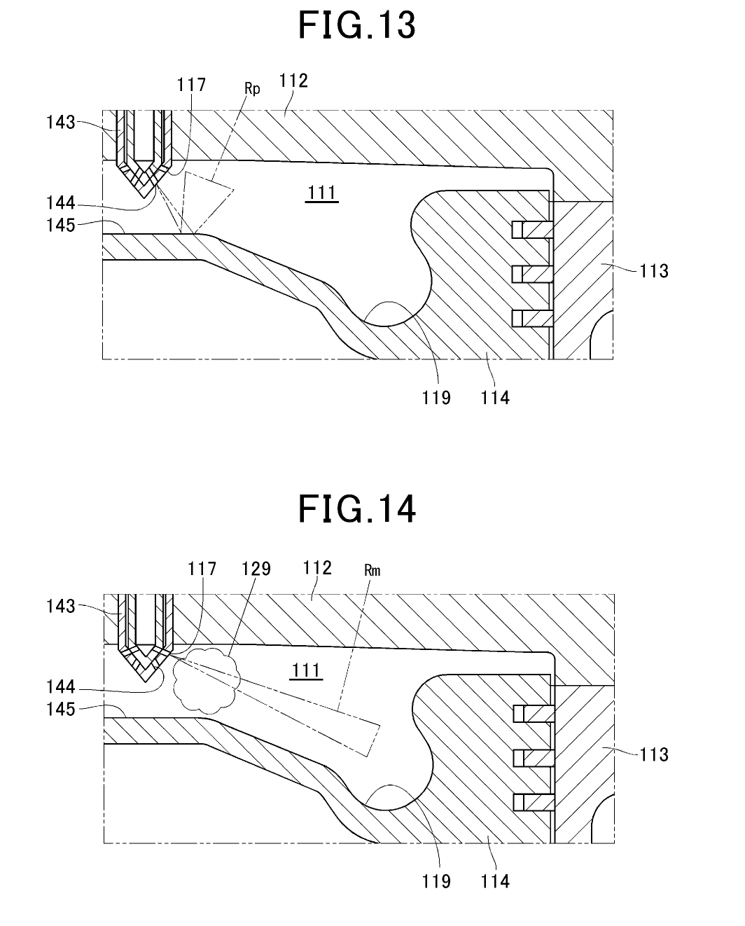

As shown in FIGS. 13 and 14, the injector 143 has two types of nozzle holes 117 and 144. As shown in FIG. 14, the injection direction of the nozzle hole 117 during the main injection faces the piston cavity 119. Meanwhile, as shown in FIG. 13, the injection direction of the nozzle hole 144 during the preceding injection faces an upper surface 145 of the piston 114 that is a partition wall of the combustion chamber 111. The injection direction of the preceding injection faces further towards the partition wall of the combustion chamber 111 than the injection direction of the main injection. As a result, the preceding spray range Rp shown in FIG. 13 is closer to the nozzle hole 117 of the injector 143 than the main spray range Rm shown in FIG. 14. For example, JP-A-2013-119836 discloses an injector that includes two types of nozzle holes in which the injection direction of one nozzle hole differs from the injection direction of the other. Therefore, a description of a detailed configuration thereof is omitted.

Even when the injection direction of the preceding injection faces further towards the partition wall of the combustion chamber 111 than that of the main injection, the preceding spray range can be set closer to the nozzle hole 117 of the injector 143 than the main spray range. Consequently, in a manner similar to that according to the first embodiment, sudden combustion can be prevented while ensuring ignitability in compression ignition. A stable diffusive combustion can be obtained.

### Fourth Embodiment

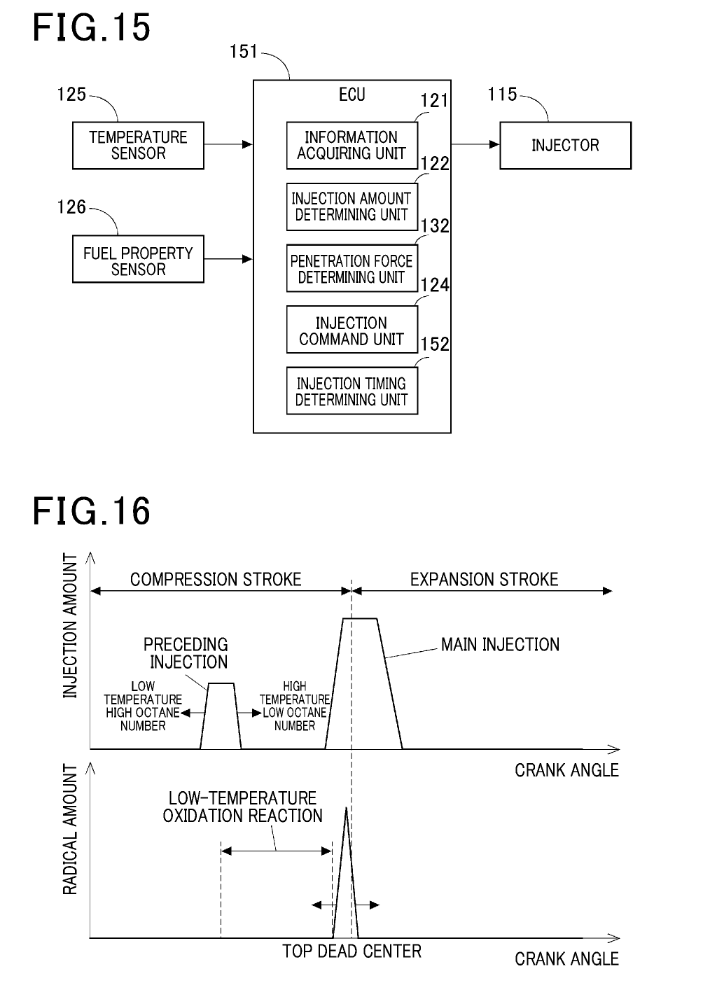

According to a fourth embodiment of the present disclosure, an injection timing determining unit 152 of an ECU 151 shown in FIG. 15 determines the ignition timing of the preceding injection based on the combustion chamber temperature and the octane value of the fuel, such that the generation timing of the radicals generated by the low-temperature oxidation reaction of the preceding spray coincides with the injection timing of the main injection. That is, the injection timing determining unit 152 controls the generation timing of the radicals based on the injection timing of the preceding injection.

Specifically, as shown in FIG. 16, the injection timing determining unit 152 delays the injection timing of the preceding injection as the combustion chamber temperature increases (that is, as the low-temperature oxidation reaction more easily progresses) and advances the injection timing of the preceding injection as the combustion chamber temperature decreases (that is, as the low-temperature oxidation reaction less easily progresses). In addition, the injection timing determining unit 152 delays the injection timing of the preceding injection as the octane number of the fuel decreases (that is, as the low-temperature oxidation reaction more easily progresses) and advances the injection timing of the preceding injection as the octane number of the fuel increases (that is, as the low-temperature oxidation reaction less easily progresses).

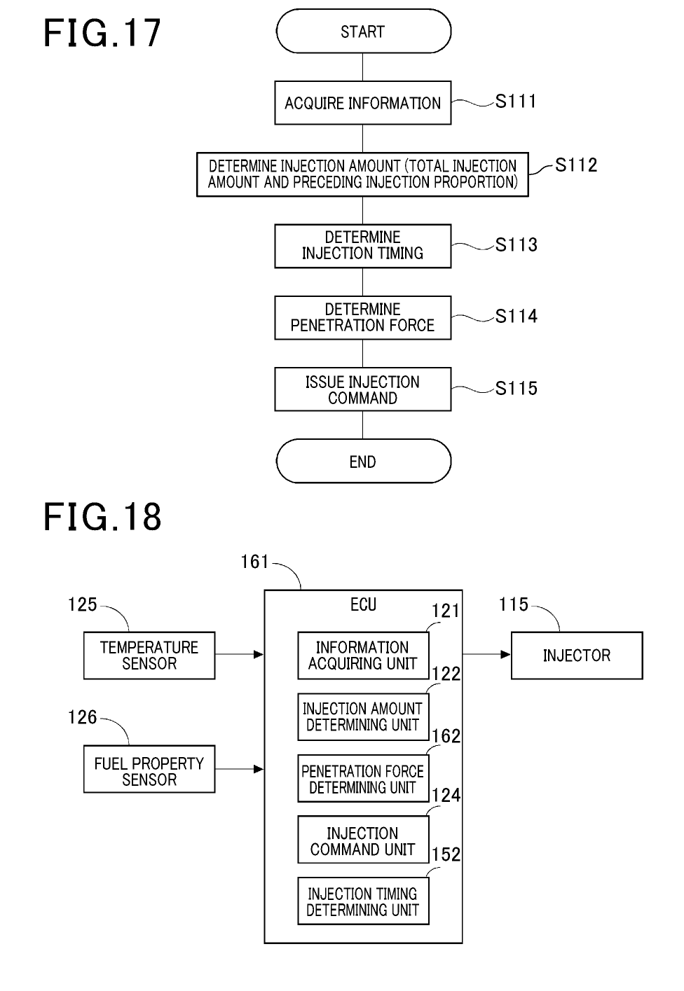

The ECU 151 performs the processes shown in FIG. 17. Steps S111, S112, S114, and S115 are similar in content to steps S101 to S104 in FIG. 8 according to the first embodiment.

At step S113 following step S112, the injection timing determining unit 152 determines the injection timing of the preceding injection based on the combustion chamber temperature and the octane number of the fuel such that the generation timing of the radicals generated by the low-temperature oxidation reaction of the preceding spray coincides with the injection timing of the main injection.

The injection timing of the preceding injection is changed in this manner based on the combustion chamber temperature and the octane number of the fuel. As a result, the generation timing of the radicals can be made to coincide with the injection timing of the main injection. Therefore, a high concentration of radicals can be supplied to the main injection at a location near the nozzle hole 117. Consequently, in a manner similar to that according to the first embodiment, sudden combustion can be prevented while ensuring ignitability in compression ignition. A stable diffusive combustion can be obtained.

### Fifth Embodiment

According to a fifth embodiment, a penetration force determining unit 162 of an ECU 161 shown in FIG. 18 reduces the injection pressure of the preceding injection compared to that of the main injection, in a manner similar to that according to the third embodiment. In addition, the penetration force determining unit 162 increases or reduces the injection pressure of the preceding injection based on the extent of delay or advance of the injection timing of the preceding injection by the injection timing determining unit 152. Specifically, the penetration force determining unit 162 reduces the injection pressure and reduces the penetration force of the preceding injection as the injection timing of the preceding injection is advanced. The penetration force determining unit 162 increases the injection pressure and increases the penetration force of the preceding injection as the injection timing of the preceding injection is delayed.

For example, when the injection timing is advanced, the amount of time over which the air-fuel mixture is diffused increases. Therefore, the radicals are not easily locally disposed near the nozzle hole. In this regard, according to the fifth embodiment, the penetration force of the preceding injection is reduced as the injection timing is advanced. As a result, diffusion of the air-fuel mixture is suppressed.

### Sixth Embodiment

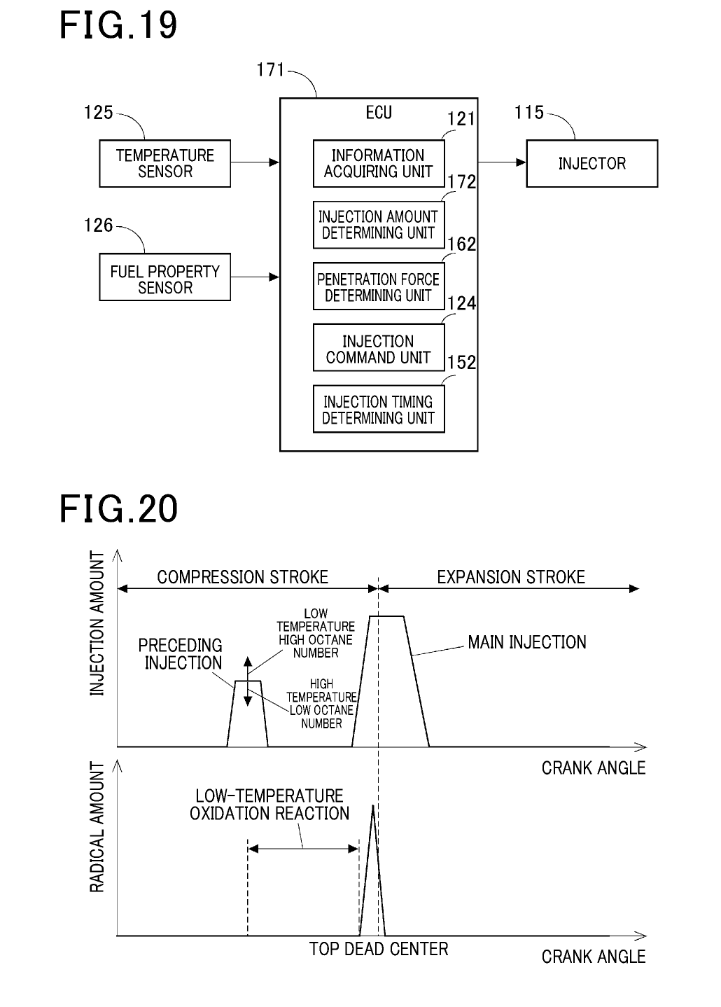

According to a sixth embodiment of the present disclosure, an injection amount determining unit 172 of an ECU 171 shown in FIG. 19 determines the preceding injection proportion based on the combustion chamber temperature and the octane value, such that the generation timing of the radicals generated by the low-temperature oxidation reaction of the preceding spray coincides with the injection timing of the main injection. That is, the injection amount determining unit 172 controls the generation timing of the radicals based on the preceding injection proportion of the preceding injection.

Specifically, as shown in FIG. 20, the injection amount determining unit 172 reduces the preceding injection proportion as the combustion chamber temperature increases (that is, as the low-temperature oxidation reaction more easily progresses) and increases the preceding injection proportion as the combustion chamber temperature decreases (that is, as the low-temperature oxidation reaction less easily progresses). In addition, the injection amount determining unit 172 reduces the preceding injection proportion as the octane value of the fuel decreases (that is, as the low-temperature oxidation reaction more easily progresses) and increases the preceding injection proportion as the octane value of the fuel increases (that is, as the low-temperature oxidation reaction becomes more difficult).

The preceding injection proportion is changed based on the combustion chamber temperature and the octane number in this manner. As a result, more radicals can be generated at the injection timing of the main injection. Therefore, a high concentration of radicals can be supplied to the main spray at a location near the nozzle hole 117. Consequently, in a manner similar to that according to the first embodiment, sudden combustion can be prevented while ensuring ignitability in compression ignition. A stable diffusive combustion can be obtained.

A low-temperature oxidation reaction speed is a function of ambient temperature, equivalent ratio, and octane number. The ECU 171 according to the sixth embodiment successively calculates the low-temperature oxidation reaction speed, and controls the injection timing and the injection amount of the preceding injection such that the radical concentration is at maximum at the main injection timing.

### First to Sixth Modifications

According to a first modification of the present disclosure, the preceding injection may be performed twice or more. In addition, the main injection may be performed twice or more.

According to a second modification of the present disclosure, for example, alcohol fuel or fuel gas may be used as fuel other than gasoline.

According to a third modification of the present disclosure, in an internal combustion engine that includes a spark plug, and switches ignition between spark ignition mode and compression ignition mode, the ECU may be used to ensure ignitability in the compression ignition mode. In addition, according to such an embodiment, the octane number of the fuel may be estimated based on an ignition timing and cylinder pressure during the spark ignition mode. In the spark ignition mode, in cases in which fuel that is easily ignitable (low octane number) is used, control to delay the ignition timing is typically performed to prevent knocking. The octane number of the fuel is estimated from information obtained through such control.

According to a fourth modification of the present disclosure, the temperature inside the combustion chamber may be estimated based on cylinder pressure that is detected by a cylinder pressure sensor. Alternatively, the temperature inside the combustion chamber may be estimated based on a temperature of cooling water that is detected by a cooling water temperature sensor. For example, a state in which cooling is performed and the temperature inside the combustion chamber does not easily increase can be assumed by the cooling water temperature being measured.

According to a fifth modification of the present disclosure, the present disclosure may be carried out by a combination of the second embodiment and the third embodiment. That is, the injection pressure of the preceding injection may be reduced compared to that of the main injection and the injection direction of the preceding injection may face further towards the partition wall of the combustion chamber than that of the main injection.

According to a sixth modification of the present disclosure, the nozzle hole diameter may remain unchanged for the preceding injection and the main injection. In addition, the injection pressure of the preceding injection may be reduced compared to that of the main injection.

The present disclosure is not limited to the first to sixth embodiments and the first to sixth modifications. Various embodiments are possible without departing from the spirit of the disclosure.

### 2. Seventh to Tenth Embodiments

Next, a plurality of embodiments of an internal combustion engine control system will hereinafter be described with reference to the drawings. Seventh to Tenth embodiments, hereafter, are collectively referred to as a “present embodiment.” Configurations among the plurality of embodiments that are essentially identical are given the same reference numbers. Descriptions thereof are omitted.

The internal combustion engine control system according to the present embodiment is a control system that controls operation of an internal combustion engine by a combustion method in which fuel contained in air is auto-ignited and combusted. According to the present embodiment, the internal combustion engine control system is basically assumed to be applied to a gasoline engine that uses gasoline for fuel. The possibility of application to fuel other than gasoline is described in another embodiment.

In the gasoline engine, improvement of theoretical efficiency through increase of compression ratio is effective for increased efficiency. This theory is based on thermal efficiency η becoming closer to 1 as compression ratio ε is increased, in an expression below that expresses a relationship among thermal efficiency η, compression ratio ε, and heat capacity ratio γ.

$$[ Formula 2 ] \\ η = 1 - \frac{1}{{ɛ}^{γ}} \qquad$$

However, at a high compression ratio, knocking, that is, auto-ignition of end gas, easily occurs. Therefore, suppression of knocking becomes an issue. As a solution for this issue, a “diffusive combustion method” is known. The diffusive combustion method is similar to a combustion method of a diesel engine, in which fuel is auto-ignited and combusted while being injected into compressed air.

In the diffusive combustion method, an air-fuel mixture is not present in the end gas. Therefore, elimination of knocking becomes possible. However, because ignitability of gasoline is low, auto-ignition is difficult. A technique for improving ignitability is required.

With regard to the above-described issue, Japanese Patent Publication No. 5906982 proposes a technique for improving the ignitability of gasoline through addition of ozone. In this technique, combustion reaction can be promoted by O radicals that are generated by ozone decomposition based on chemical formula 1.

O₃⇒O+O₂ [Chemical formula 1]

However, ozone decomposes and generates O radicals at about 500 K to 600 K. The generated radicals are unstable active substances. Most of the generated radicals rapidly dissipate at a time constant of an order of about several tens of microseconds.

Meanwhile, in the diffusive combustion method, when fuel is injected near a compression end (that is, a top dead center of a piston), the temperature at the compression end in the high compression ratio engine becomes about 800 K to 900 K. Therefore, regarding the technique in which ozone is added in the conventional technology disclosed in Japanese Patent Publication No. 5906982, supplying the radicals to the fuel becomes difficult.

Therefore, according to the seventh to ninth embodiments, a following technique is proposed. That is, in the diffusive combustion method of the high compression ratio gasoline engine, when fuel injection is performed near the top dead center at which an internal temperature of a combustion chamber is high at about 800 K to 900 K, radicals are effectively supplied to the fuel.

Specifically, an “added substance that generates radicals at a temperature equal to or higher than 700 K” is supplied. As a result, the radicals that are generated are less likely to immediately dissipate even in an environment of 800 K to 900 K. An embodiment in which hydrogen peroxide that generates OH radicals is supplied as an example of the added substance will be described in detail.

In addition, according to the tenth embodiment, an embodiment in which switching is performed between a mode in which hydrogen peroxide is supplied as the added substance that generates radicals and a mode in which ozone is supplied as the added substance that generates radicals will be described.

As a rule, regarding description of the added substance, the added substance is described as “hydrogen peroxide” and “ozone” in the specification. The added substance is described as “H₂O₂” and “O₃” using chemical formulas in the drawings.

### Seventh Embodiment

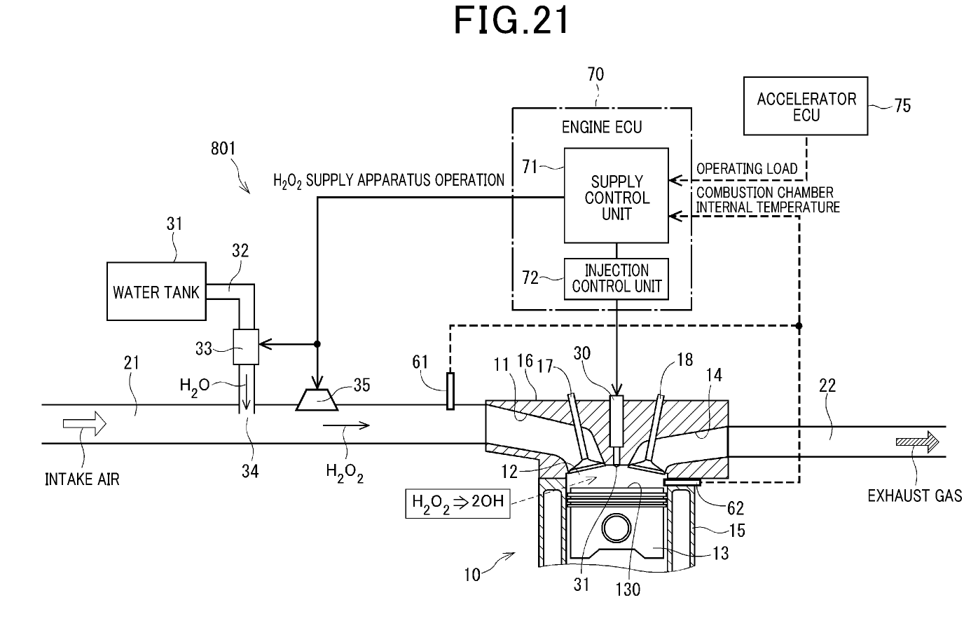

The seventh embodiment will be described with reference to FIGS. 21 to 26.

For example, an internal combustion engine 10 is a multi-cylinder engine that is mounted in a vehicle. A piston 13 moves in a reciprocating manner inside each cylinder 15. FIG. 21 shows a cross-sectional view of a head-side portion of a single cylinder 15. A diverging flow from an intake passage 21 to an intake manifold 11 and a merging flow from an exhaust manifold 14 to an exhaust passage 22 are omitted in FIG. 21.

A combustion chamber 12 is a space that is compartmentalized by an inner surface of the cylinder 15, a bottom surface of a cylinder head 16, and a top surface 130 of the piston 13. An intake valve 17 opens and closes an intake port that communicates from the intake manifold 11 to the combustion chamber 12. An exhaust valve 18 opens and closes an exhaust port that communicates from the combustion chamber 12 to the exhaust manifold 14. A fuel injection valve 30 injects fuel into the combustion chamber 12.

In FIG. 21, an air filter and a throttle valve in the intake passage 21, an exhaust purification catalyst in the exhaust passage 22, and the like are omitted.

In an internal combustion engine control system 801 according to the seventh embodiment, a water tank 31, a water supply passage 32, and a water introducing unit 33 are provided. The water introducing unit 33 introduces water (that is, H₂O) held in the water tank 31 into the intake passage 21. In addition, an ultrasonic wave generation apparatus 35 is provided in the intake passage 21, further downstream from an introduction opening 34 of the water supply passage 32.

The ultrasonic wave generation apparatus 35 irradiates ultrasonic waves onto the water that is introduced into the intake passage 21 by the water introducing unit 33. As a result, hydrogen peroxide is generated. That is, the water introducing unit 33 and the ultrasonic wave generation apparatus 35 according to the seventh embodiment function as a “hydrogen peroxide supply apparatus.”

Japanese Patent Publication No. 4103525 discloses a technology related to an exhaust purification apparatus. The exhaust purification apparatus irradiates ultrasonic waves near 200 kHz onto exhaust gas in an upstream region of a three-way catalyst or the like. The exhaust purification apparatus thereby changes moisture contained in the exhaust gas to hydrogen peroxide. In this technology, hydrogen peroxide is used to improve purification performance by oxidizing unburned hydrocarbons (HC) and carbon monoxide (CO), and resolving HC poisoning of an NOx storage reduction catalyst.

In this regard, according to the seventh embodiment, hydrogen peroxide is generated during intake for other purposes.

According to the seventh embodiment, hydrogen peroxide is an example of an “added substance that generates radicals in the intake passage 21 or inside the combustion chamber 12.” In addition, the “hydrogen peroxide supply apparatus” configured by the water introducing unit 33 and the ultrasonic wave generation apparatus 35 corresponds to an aspect of an “added substance supply apparatus.”

Hydrogen peroxide is decomposed in the intake passage 21 or inside the combustion chamber 12, based on a chemical formula 2, and generates OH radicals. The OH radicals are supplied into the combustion chamber 12. As a result, ignitability of fuel improves.

H₂O₂⇒2OH [Chemical formula 2]

In FIG. 21, a temperature sensor 61 is provided in the intake passage 21, near the internal combustion engine 10. The temperature 61 is a thermocouple or the like, and detects an intake-air temperature. In addition, a temperature sensor 62 is provided so as to protrude into the combustion chamber 12 from an inner surface of the cylinder 15. The temperature sensor 62 is a thermocouple or the like, and directly detects a combustion chamber internal temperature. However, only at least either of the temperature sensors 61 and 62 is required to be provided.

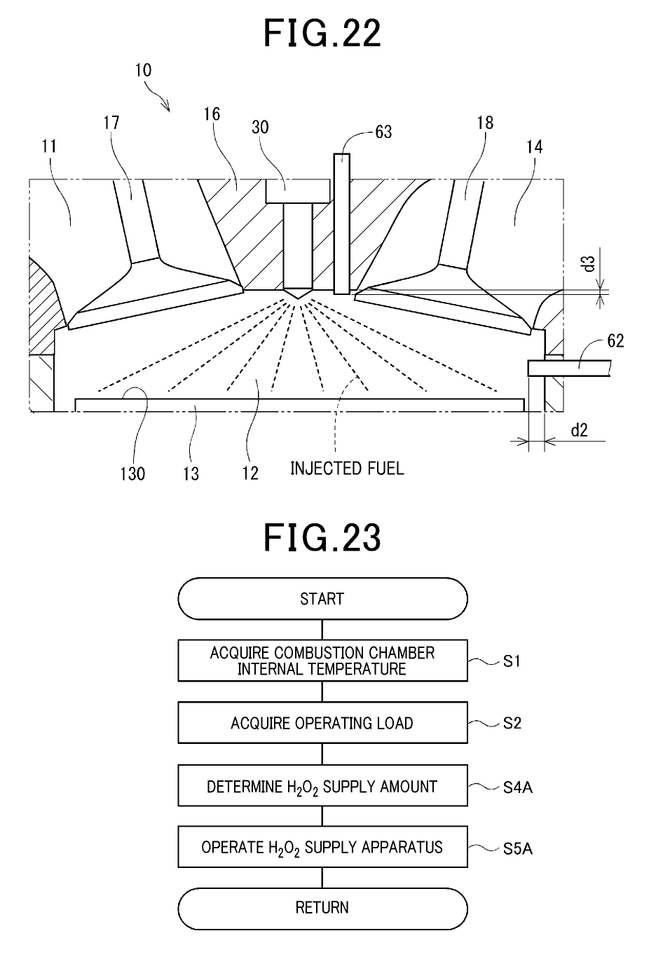

Furthermore, as a configuration in which a temperature sensor is provided in the combustion chamber 12, as shown in FIG. 22, a temperature sensor 63 may be provided on the bottom surface of the cylinder head 16, adjacent to the fuel injection valve 30. However, the combustion chamber internal temperature cannot be accurately detected should a spray injected from the fuel injection valve 30 hit the temperature sensor 63. Therefore, an amount of protrusion d3 of the temperature sensor 63 into the combustion chamber 12 is preferably zero or as miniscule an amount as possible to prevent interference with the spray. Meanwhile, the temperature sensor 62 that is provided in a position away from the fuel injection valve 30 is hardly affected by the spray. Therefore, an amount of protrusion d2 of the temperature sensor 62 may be relatively large.

An engine electronic control unit (ECU) 70 includes a supply control unit 71, an injection control unit 72, and the like. The engine ECU 70 controls the operation of the internal combustion engine 10.

In general terms, the supply control unit 71 controls a “supply amount of the added substance that generates radicals.” Specifically, according to the seventh embodiment, the supply control unit 71 controls a hydrogen peroxide supply amount of hydrogen peroxide supplied by the water introducing unit 33 and the ultrasonic wave generation apparatus 35.

The injection control unit 72 controls a fuel injection amount and an injection timing of fuel injection by the fuel injection valve 30.

The supply control unit 71 estimates the combustion chamber internal temperature based on the intake-air temperature detected by the temperature sensor 61 provided in the intake passage 21. Alternatively, the supply control unit 71 acquires the temperature detected by the temperature sensor 62 provided in the combustion chamber 21 as the combustion chamber internal temperature.

In addition, the supply control unit 71 acquires an operating load of the internal combustion engine 10. For example, in the case of the internal combustion engine 10 of a vehicle, an accelerator position is acquired from an accelerator ECU 75 as a parameter expressing the operating load.

FIG. 23 shows a flowchart of hydrogen peroxide supply control according to the seventh embodiment. Reference symbol S in the description of the flowchart hereafter denotes “step.” In addition, the steps in flowcharts according to subsequent embodiments that are essentially identical to the steps according to the seventh embodiment are given the same step numbers. Descriptions thereof are omitted.

At S1, the supply control unit 71 acquires the combustion chamber internal temperature from the temperature sensor 61 or 62. At S2, the supply control unit 71 acquires the operating load from the accelerator ECU 75. S1 and S2 may be performed in either order, that is, S1 followed by S2 or S2 followed by S1.

At S4A, the supply control unit 71 determines the hydrogen peroxide supply amount based on the combustion chamber internal temperature and the operating load. The fuel less easily auto-ignites as the combustion chamber internal temperature decreases and the operating load decreases. Therefore, under such conditions in which auto-ignition is difficult, the amount of hydrogen peroxide is preferably increased and ignitability thereby improved.

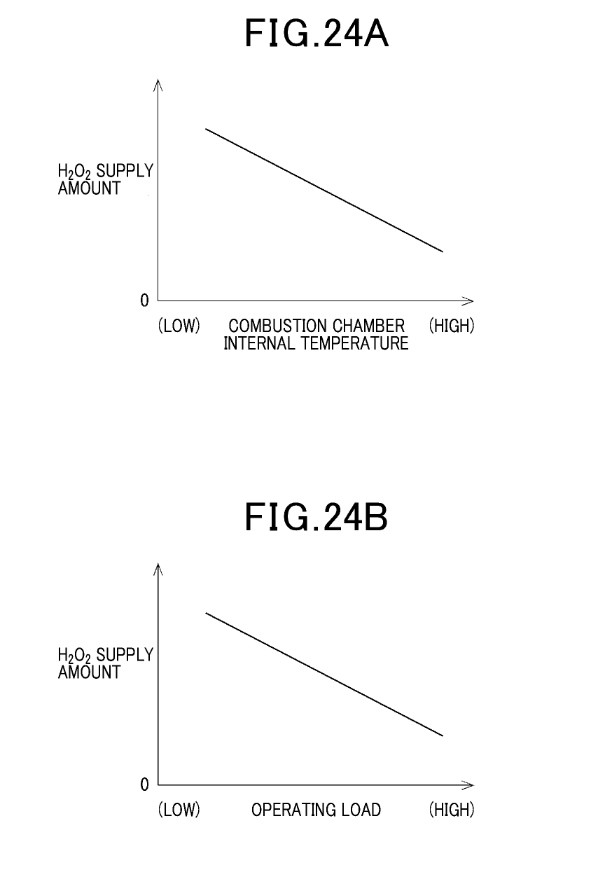

Here, as shown in FIG. 24A, the supply control unit 71 increases the hydrogen peroxide supply amount as the combustion chamber internal temperature decreases. In addition, as shown in FIG. 24B, the supply control unit 71 increases the hydrogen peroxide supply amount as the operating load decreases.

At S5A, the supply control unit 71 operates the water introducing unit 33 and the ultrasonic wave generation apparatus 35, which serve as the “hydrogen peroxide supply apparatus,” based on the determined supply amount.

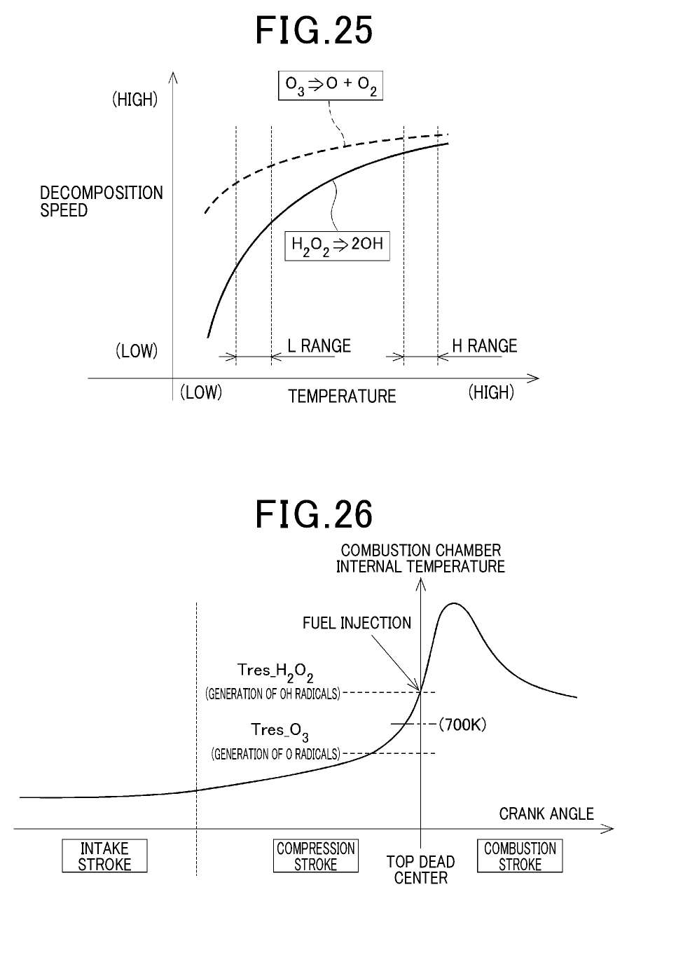

Next, working effects according to the seventh embodiment will be described with reference to FIGS. 25 and 26.

FIG. 25 shows a relationship between temperature, and decomposition speeds of hydrogen peroxide and ozone.

Ozone has a high decomposition speed even in a low-temperature L range. In accompaniment with temperature increase, the decomposition speed of ozone increases at a relatively gentle slope towards a high-temperature H region. Meanwhile, the decomposition speed of hydrogen peroxide is significantly lower than that of ozone in the low-temperature L range. In accompaniment with temperature increase, the decomposition speed of hydrogen peroxide increases at a relatively steep slope towards the high-temperature H range.

For example, the L range is considered to correspond to a temperature range of about 500 K to 600 K. The H range is considered to correspond to a temperature range of about 800 K to 900 K.

FIG. 26 shows a relationship between a crank angle and the combustion chamber internal temperature. The crank angle is correlated with the position of the piston 13.

From an intake stroke to midway through a compression stroke, the combustion chamber internal temperature is lower than a decomposition temperature Tres_O₃ of ozone. From the end of the compression stroke, the combustion chamber internal temperature suddenly starts to increase. The combustion chamber internal temperature when fuel injection is performed at the top dead center is equivalent to a decomposition temperature Tres_H₂O₂ of hydrogen peroxide. At the combustion stroke after the top dead center, the combustion chamber internal temperature further increases and reaches a peak. Subsequently, the combustion chamber internal temperature gradually decreases.

Here, for example, with reference to 700 K, the temperature Tres_O₃ at which ozone decomposes and generates O radicals is lower than 700 K. The decomposition temperature Tres_H₂O₂ of hydrogen peroxide is higher than 700 K. That is, hydrogen peroxide decomposes at a higher temperature than ozone. OH radicals can be generated at a temperature equal to or higher than 700 K.

In this manner, according to the seventh embodiment, hydrogen peroxide is supplied to the intake air. As a result, OH radicals can be generated inside the combustion chamber 12, and ignitability of fuel in diffusive combustion can be improved.

In addition, the supply control unit 71 increases the hydrogen peroxide supply amount as conditions become less conducive to ignition of the fuel, such as when the combustion chamber internal temperature is low or when the operating load is low. Ignitability can thereby be improved.

Furthermore, the ultrasonic wave generation apparatus 35 irradiates ultrasonic waves onto the water introduced into the intake passage 21. As a result, hydrogen peroxide can be easily generated.

### Eighth Embodiment

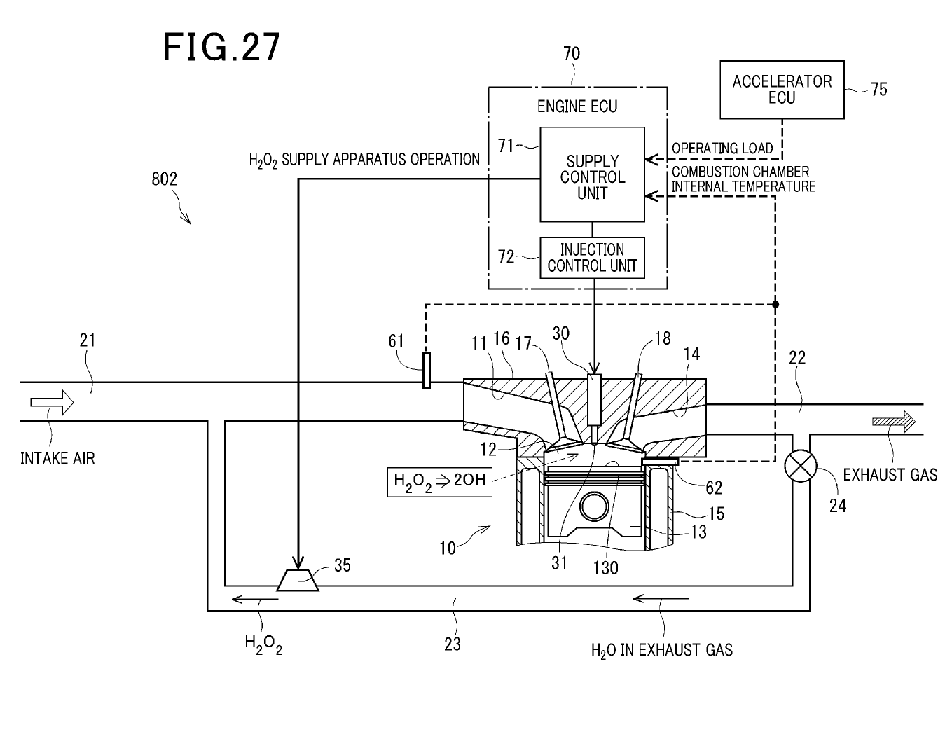

The eighth embodiment will be described with reference to FIG. 27.

An internal combustion engine control system 802 according to the eighth embodiment includes an exhaust gas recirculation (EGR) system. The internal combustion engine control system 802 is provided with an EGR passage 23 that branches from the exhaust passage 22 and communicates with the intake passage 21. When an EGR valve 24 is open, a portion of exhaust gas containing moisture that has been generated by combustion is recirculated to the intake passage 21 via the EGR passage 23.

The ultrasonic wave generation apparatus 35 is provided in the EGR passage 23. The ultrasonic wave generation apparatus 35 irradiates ultrasonic waves onto the recirculated exhaust gas, thereby changing the moisture contained in the exhaust gas to hydrogen peroxide. Therefore, the ultrasonic wave generation apparatus 35 functions as a “hydrogen peroxide supply apparatus.”

The hydrogen peroxide supplied by the ultrasonic wave generation apparatus 35 is supplied into the combustion chamber 12 together with the intake air. OH radicals are then generated. Consequently, ignitability of fuel in diffusive combustion is improved.

FIGS. 23 and 24 according to the seventh embodiment are applicable as a flowchart of hydrogen peroxide supply control, and a map of the hydrogen peroxide supply amount based on the combustion chamber internal temperature and the operating load, according to the eighth embodiment. At S5A in the flowchart, the supply control unit 71 operates the ultrasonic wave generation apparatus 35 as the “hydrogen peroxide supply apparatus” and supplies hydrogen peroxide to the exhaust gas being recirculated through the intake passage 21.

According to the eighth embodiment, working effects similar to those according to the seventh embodiment are achieved. In addition, in the internal combustion engine control system 802 that includes the exhaust gas recirculation system, hydrogen peroxide can be supplied through effective use of the moisture in the exhaust gas.

### Ninth Embodiment

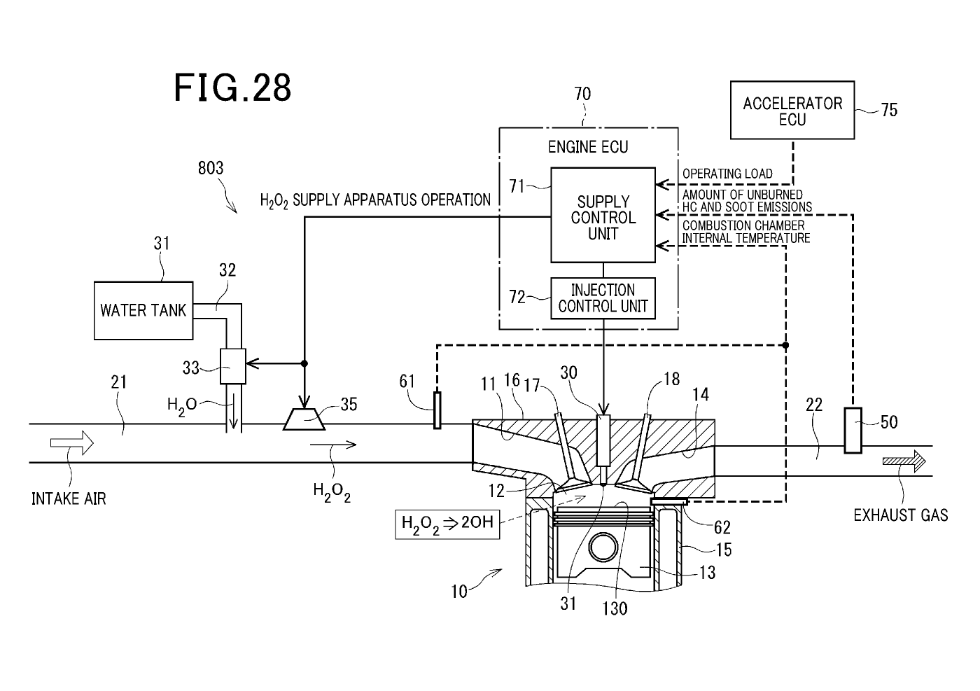

The ninth embodiment will be described with reference to FIGS. 28 to 30.

As shown in FIG. 28, an internal combustion engine control system 803 according to the ninth embodiment has the configuration of the control system 801 according to the seventh embodiment. In addition, in the internal combustion engine control system 803, a measurement apparatus 50 is provided in the exhaust passage 22. The measurement apparatus 50 measures an amount of unburned HC and soot (SOOT) emissions contained in the exhaust gas, and notifies the supply control unit 71 of the measured amount.

In the internal combustion engine 10 of a vehicle, for example, the amount of unburned HC and SOOT emissions tends to increase during acceleration, cooling, and the like of the vehicle. Reduction of the amount of unburned HC and SOOT emissions is required.

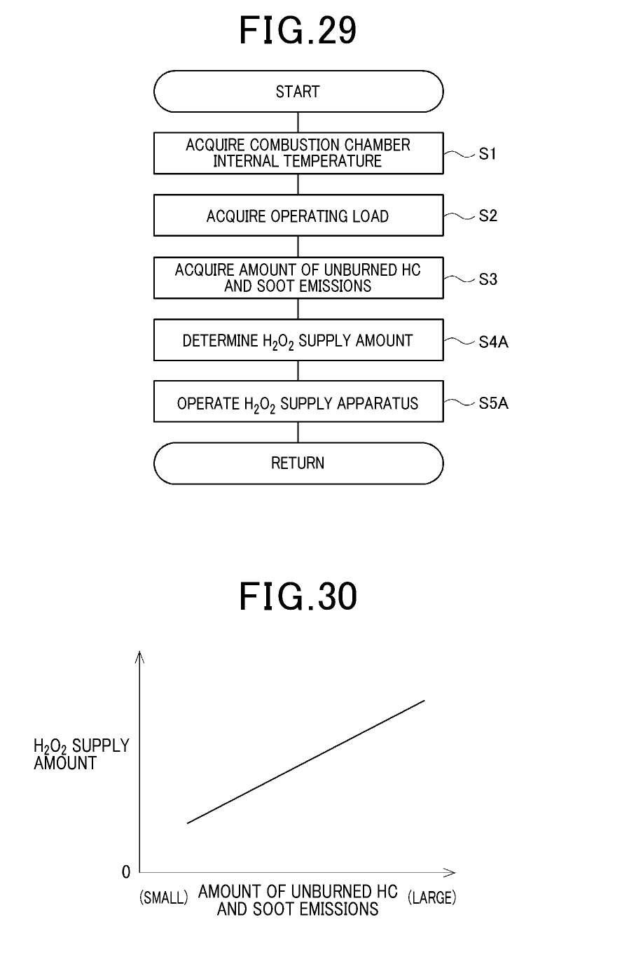

S1 and S2 in a supply control flowchart in FIG. 29 are identical to those in FIG. 23 according to the seventh and eighth embodiments. At S3 following S2, the supply control unit 71 acquires the amount of unburned HC and SOOT emissions.

As shown in a map in FIG. 30, the supply control unit 71 reduces an amount of unburned substance emission by increasing the hydrogen peroxide supply amount as the amount of unburned HC and SOOT emissions in the exhaust gas increases.

That is, at S4A in the flowchart, the supply control unit 71 determines the hydrogen peroxide supply amount based on three parameters, that is, the combustion chamber internal temperature, the operating load, and the amount of unburned HC and SOOT emissions. Then, at S5A, the supply control unit 71 operates the ultrasonic wave generation apparatus 35, which serves as the “hydrogen peroxide generation apparatus,” based on the determined supply amount.

According to the ninth embodiment, working effects similar to those according to the seventh embodiment are achieved. In addition, the hydrogen peroxide supply amount is increased as the amount of unburned HC and SOOT emissions increases. As a result, oxidation power can be increased. Thus, the amount of unburned substance emission can be reduced.

### Tenth Embodiment

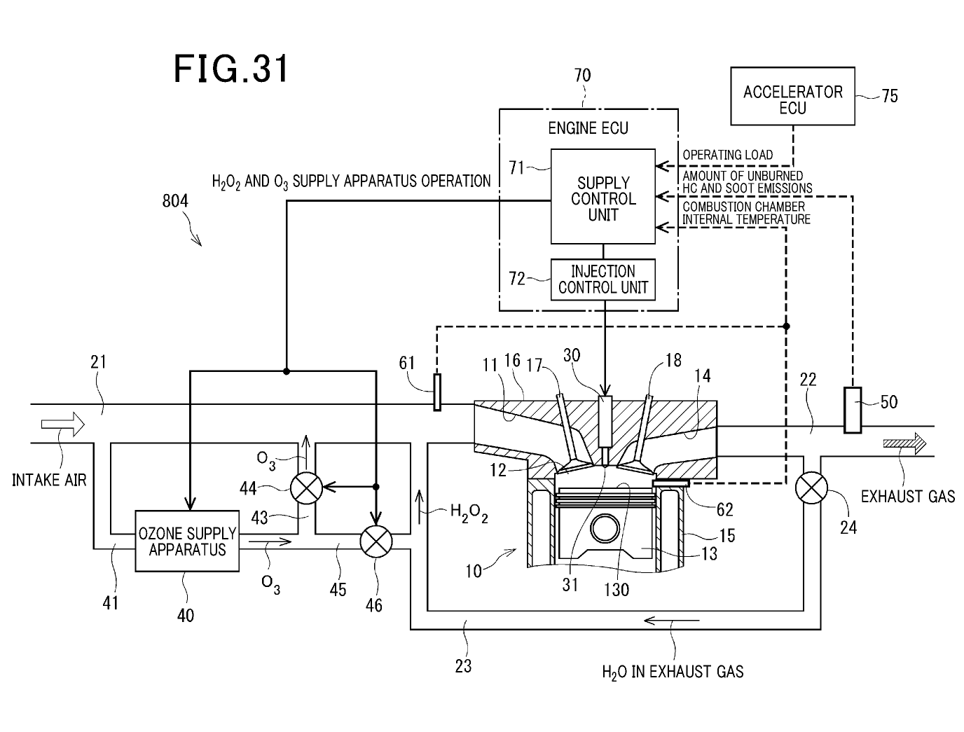

The tenth embodiment will be described with reference to FIGS. 31 to 36.

As shown in FIG. 31, an internal combustion engine control system 804 according to the tenth embodiment is provided with the EGR passage 23 of the exhaust gas recirculation system, in a manner similar to the control system 802 according to the eighth embodiment.

In addition, the internal combustion engine control system 804 includes an ozone supply apparatus 40. The ozone supply apparatus 40 supplies ozone to the intake passage 21 or the combustion chamber 12, as an added substance that generates O radicals.

A portion of the intake air flows into the ozone supply apparatus 40 via an inflow passage 41 that branches from the intake passage 21 on an upstream side. When a first valve 44 is opened, intake air containing ozone supplied by the ozone supply apparatus 40 is introduced into the intake passage 21 on the downstream side, via a first outflow passage 43. When a second valve 46 is opened, the intake air containing ozone is introduced into the EGR passage 23, via a second outflow passage 45.

The ozone that is supplied to the intake passage 21 via the first outflow passage 43 generates O radicals in the intake passage 21 or the combustion chamber 12.

The ozone that is supplied to the EGR passage 23 via the second outflow passage 45 changes moisture contained in the recirculated exhaust gas to hydrogen peroxide based on a chemical formula 3.

O₃+H₂O⇒O₂+H₂O₂ [Chemical formula 3]

That is, through the work of supplying ozone to the EGR passage 23 and generating hydrogen peroxide using the moisture in the exhaust gas, the ozone supply apparatus 40 also functions as a “hydrogen peroxide supply apparatus.” The hydrogen peroxide generated in the EGR passage 23 generates OH radicals in the intake passage 21 or the combustion chamber 12.

Here, a configuration in which the second valve 46 remains closed at all times and the entirety of the ozone supplied by the ozone supply apparatus 40 is supplied to the intake passage 21 essentially does not differ from the conventional technology in Japanese Patent Publication No. 5906982. Meanwhile, a configuration in which the first valve 44 remains closed at all times and the entirety of the ozone supplied by the ozone supply apparatus 40 is supplied to the EGR passage 23 is considered to not significantly differ from the configurations according to the seventh to ninth embodiments, even should a slight amount of ozone that is not used to generate the hydrogen peroxide remain.

Therefore, according to the tenth embodiment, technological significance is found in both the first valve 44 and the second valve 46 being simultaneously opened and both hydrogen peroxide and ozone being supplied at at least some ranges of the combustion chamber internal temperature and operating load.

The supply control unit 71 controls absolute amounts of the hydrogen peroxide supply amount and the ozone supply amount, and a ratio of the hydrogen peroxide supply amount to the ozone supply amount by adjusting the extent of opening of each valve 44 and 46, at ranges at which both hydrogen peroxide and ozone are supplied.

As described above, ozone decomposes at about 500 K to 600 K, and most of the generated O radicals immediately dissipate. Therefore, at a temperature equal to or higher than 700 K in particular, hydrogen peroxide that is less prone to decomposition than ozone being mainly supplied is effective for improvement in ignitability. However, even should the temperature be equal to or higher than 700 K, the O radicals in the combustion chamber 12 do not completely dissipate. The effects of ozone being supplied can be expected to a certain extent. Consequently, an aim of the tenth embodiment is overall control of the supply amounts of ozone and hydrogen peroxide.

As the configuration by which hydrogen peroxide is supplied, the ultrasonic wave generation apparatus 35 may be used in a manner similar to that according to the seventh and eighth embodiments, instead of the “configuration in which ozone is supplied to the EGR passage 23 and moisture in the exhaust gas is changed to hydrogen peroxide” shown in FIG. 31. In this case, the ozone supply apparats and the hydrogen peroxide supply apparatus are independently configured.

In addition, in the control system 804 shown in FIG. 31, the measurement apparatus 50 for measuring the amount of unburned HC and SOOT emissions is provided in the exhaust passage 22 in a manner similar to that according to the ninth embodiment. However, the measurement apparatus 50 may not be provided.

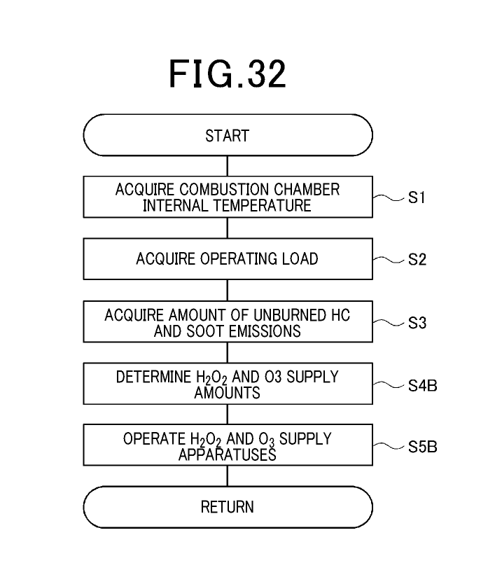

S1, S2, and S3 in a supply control flowchart in FIG. 32 are identical to those in FIG. 29 according to the ninth embodiment. At S4B, ozone is added to S4A in FIGS. 23 and 29, and the supply control unit 71 determines the supply amounts of hydrogen peroxide and ozone. In a similar manner, ozone is added to S5A in FIGS. 23 and 29, and the supply control unit 71 operates the supply apparatuses for hydrogen peroxide and ozone.

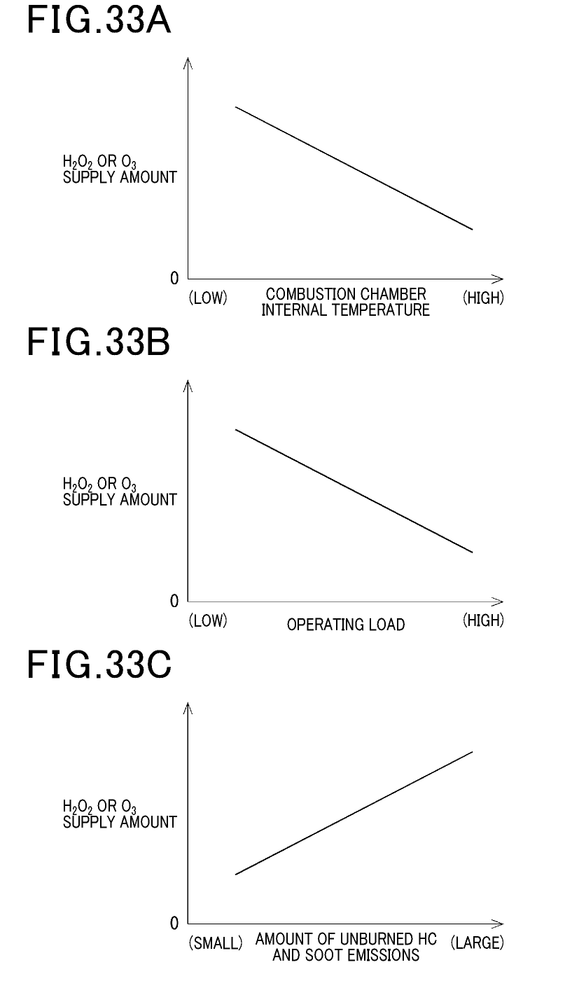

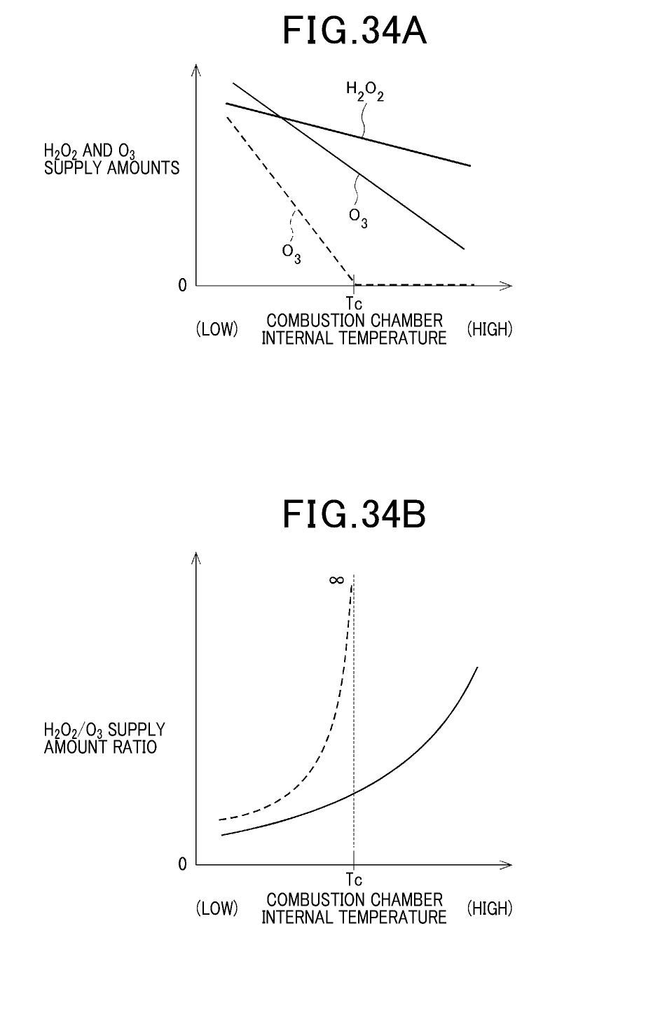

FIGS. 33A, 33B, and 33C are respectively maps in which “hydrogen peroxide supply amount” indicated on the vertical axes of the maps in FIGS. 34A, 34B, and 30 is replaced with “hydrogen peroxide or ozone supply amount.”

The supply control unit 71 increases the supply amount of at least either of hydrogen peroxide and ozone as the combustion chamber internal temperature decreases or the operating load of the internal combustion engine 10 decreases. In addition, the supply control unit 71 increases the supply amount of at least either of hydrogen peroxide and ozone as the amount of unburned HC and SOOT emissions in the exhaust gas increases. For example, the supply control unit 71 may increase the supply amount of either of hydrogen peroxide and ozone based on the above-described relationship, and set the supply amount of the other to a fixed amount regardless of the combustion chamber internal temperature, the operating load, and the amount of unburned HC and SOOT emissions.

In addition, the supply control unit 71 changes the balance between the hydrogen peroxide supply amount and the ozone supply amount based on the combustion chamber internal temperature. That is, the supply control unit 71 increases the ratio of the hydrogen peroxide supply amount to the ozone supply amount as the combustion chamber internal temperature increases. The supply control unit 71 reduces the ratio of the hydrogen peroxide supply amount to the ozone supply amount as the combustion chamber internal temperature decreases.

That is, for example, with reference to about 700 K, when the combustion chamber internal temperature is relatively low, ozone, which decomposes at a low temperature, is preferentially supplied. When the combustion chamber internal temperature is relatively high, hydrogen peroxide, which decomposes at a high temperature, is preferentially supplied. Consequently, ignitability of fuel can be effectively improved based on the combustion chamber internal temperature.

In one example, as indicated by solid lines in FIG. 34A, the supply control unit 71 increases both of the hydrogen peroxide supply amount and the ozone supply amount as the combustion chamber internal temperature decreases, such that a gradient of increase in the ozone supply amount in relation to an amount of decrease in the combustion chamber internal temperature is greater than a gradient of increase in the hydrogen peroxide supply amount.

As a result, as indicated by a solid line in FIG. 34B, the ratio of (hydrogen peroxide supply amount/ozone supply amount) increases as the combustion chamber internal temperature increases.

In another example, as indicated by a broken line in FIG. 34A, the supply control unit 71 sets the ozone supply amount to zero when the combustion chamber internal temperature ranges from a critical temperature Tc and higher. The supply control unit 71 increases the ozone supply amount as the combustion chamber internal temperature decreases, when the combustion chamber internal temperature is below the critical temperature Tc.

In this case, as indicated by a broken line in FIG. 34B, the ratio of (hydrogen peroxide supply amount/ozone supply amount) is infinite when the combustion chamber internal temperature ranges from the critical temperature Tc and higher. In this manner, the concept of “increasing the supply amount ratio” includes an increase to infinity.

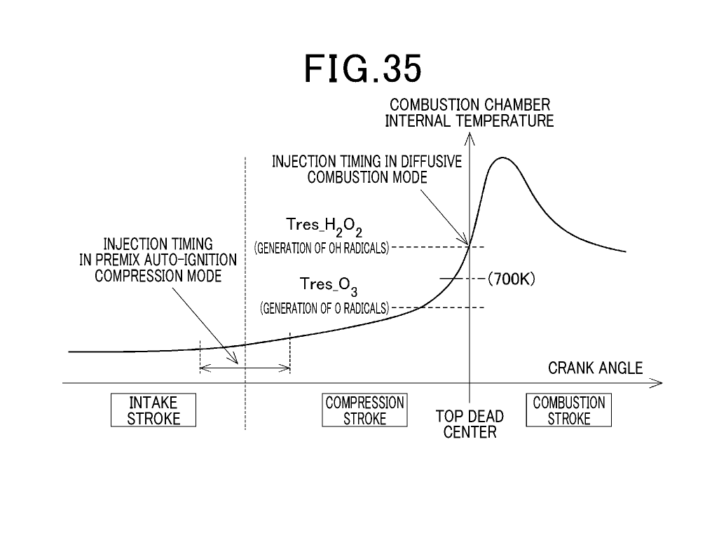

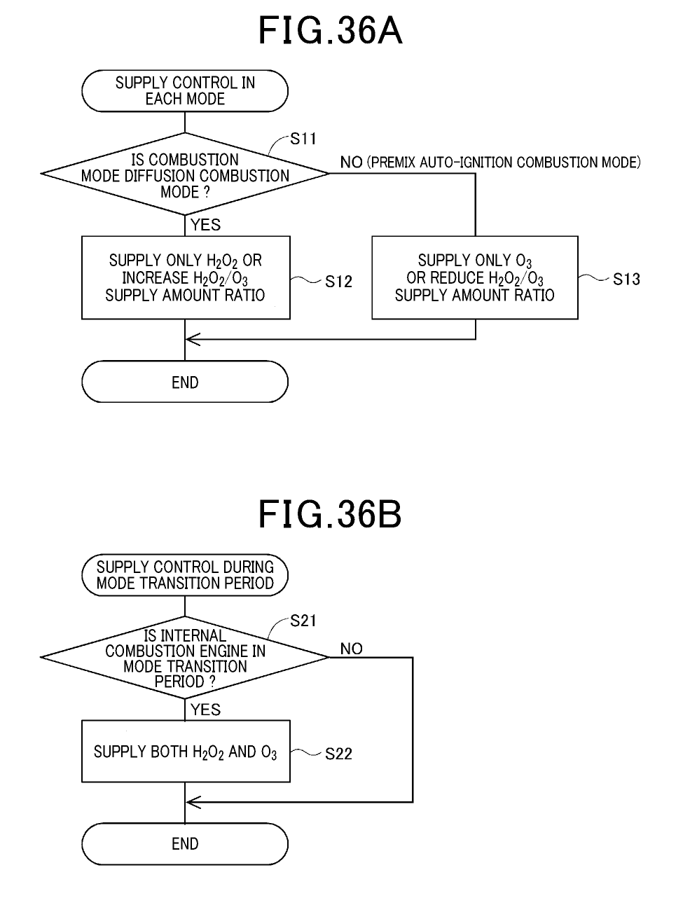

Next, combustion mode switching control to which the tenth embodiment is applied will be described with reference to FIGS. 35, 36A, and 36B. The internal combustion engine control system 804 is configured as a system that switches between a diffusive combustion mode and a premixing auto-ignition combustion mode.

In the premixing auto-ignition combustion mode, a pre-mixture of fuel and air is compressed, auto-ignited, and combusted. The premix auto-ignition combustion mode corresponds to HCCI described in Japanese Patent Publication No. 5906982 and the like. A separate fuel injection valve for the premixing auto-ignition combustion mode may be provided in the intake passage.

In the diffusive combustion mode, fuel is combusted by being injected into compressed air, in a manner similar to that in a diesel engine as described above.

The premixing auto-ignition combustion mode enables high ignitability but is unsuitable for cases in which the operating load is high. The diffusive combustion mode can be applied to cases in which the operating load is high, but results in poor ignitability. Therefore, the engine ECU 70 switches the combustion mode based on the operating load and the like, to make selective use of the respective advantages of the two modes. For example, the injection control unit 72 of the engine ECU 70 changes the injection timing of the fuel injection valve 30.

As shown in FIG. 35, in the premixing auto-ignition combustion mode, fuel is injected at the intake stroke or an early stage of the compression stroke, that is, before midway through the compression stroke when ozone is mainly decomposed, to enable mixing of fuel and air. Therefore, in the premixing auto-ignition combustion mode, the supply control unit 71 can supply O radicals to the fuel and improve ignitability by preferentially supplying ozone.

Meanwhile, in the diffusive combustion mode, fuel is injected near the top dead center at the end of the compression stroke. Therefore, in the diffusive combustion mode, the supply control unit 71 can supply OH radicals to the fuel and improve ignitability by preferentially supplying hydrogen peroxide, which decomposes at a higher temperature than ozone.

FIG. 36A is a flowchart of supply control in each combustion mode.

At S11, the engine ECU 70 identifies the combustion mode. When the combustion mode is the diffusive combustion mode, the engine ECU 70 determines YES at S11 and proceeds to S12. When the combustion mode is the premixing auto-ignition combustion mode, the engine ECU 70 determines NO at S11 and proceeds to S13.

When the combustion mode is the diffusive combustion mode, at S12, the supply control unit 71 supplies only hydrogen peroxide or increases the ratio of (hydrogen peroxide supply amount/ozone supply amount). Supplying only hydrogen peroxide is equivalent to the ratio of (hydrogen peroxide supply amount/ozone supply amount) being increased to infinity.

When the combustion mode is the premixing auto-ignition combustion mode, at S13, the supply control unit 71 supplies only ozone or reduces the ratio of (hydrogen peroxide supply amount/ozone supply amount). Supplying only ozone is equivalent to the ratio of (hydrogen peroxide supply amount/ozone supply amount) being set to zero.

Consequently, in the premixing auto-ignition combustion mode, ignitability can be improved mainly by the O radicals generated by ozone. In the diffusive combustion mode, ignitability can be improved mainly by the OH radicals generated by hydrogen peroxide.

FIG. 36B is a flowchart of supply control during a mode transition period.

Here, a configuration in which only hydrogen peroxide is supplied in the diffusive combustion mode and only ozone is supplied in the premixing auto-ignition combustion mode is assumed. A period from when the engine ECU 70 determines that the combustion mode is to be changed in accompaniment with variation in the operating load and the like, until the elapse of a predetermined amount of time or movement over a predetermined crank angle range is defined as the “mode transition period.”

At S21, the supply control unit 71 determines whether or not the internal combustion engine 10 is in the mode transition period.

When the internal combustion engine 10 is in the mode transition period and a YES determination is made at S21, at S22, the supply control unit 71 supplies both hydrogen peroxide and ozone. When the mode transition period ends, either of hydrogen peroxide and ozone is supplied based on the combustion mode after the transition. As a result, ignition stability during combustion mode switching can be ensured.

In this manner, the tenth embodiment is effectively applied to a system that switches between the diffusive combustion mode and the premixing auto-ignition combustion mode. Supplying of ozone in the premixing auto-ignition combustion mode itself is a technology disclosed in Japanese Patent Publication No. 5906982. However, Japanese Patent Publication No. 5906982 does not mention switching between the premixing auto-ignition combustion mode and the diffusive combustion mode. Furthermore, Japanese Patent Publication No. 5906982 does not mention in any way the concept of generating OH radicals by supplying hydrogen peroxide in the diffusive combustion mode.

Therefore, according to the tenth embodiment, the present disclosure has unique technological significance in that radicals are generated through appropriate selective use of different added substances, in accompaniment with switching of the combustion mode.

### Seventh to Ninth Modifications

(a) According to a seventh modification of the present disclosure, the radicals that are generated by the added substance may be radicals other than the O radicals and the OH radicals given as examples according to the above-described embodiments. In other words, in addition to ozone and hydrogen peroxide, the added substance to be supplied by the added substance supply apparatus is merely required to be a substance that generates radicals of some sort at a temperature equal to or higher than 700 K. Furthermore, as long as chemical reaction is not adversely affected, a mixture of a plurality of types of radicals may be supplied.

(b) According to a eighth modification of the present disclosure, in addition to gasoline, the fuel used in the internal combustion engine may be an alcohol fuel or fuel gas.

(c) According to a ninth modification of the present disclosure, the internal combustion engine is not limited to use in vehicles and may be used in other conveyance and general machinery.

The present disclosure is not limited in any way to the seventh to tenth embodiments and the seventh to ninth modifications. Various embodiments are possible without departing from the spirit of the disclosure.

1. An internal combustion engine control apparatus that includes a fuel injection apparatus injecting fuel into a combustion chamber a plurality of times during a single cycle, and that controls an internal combustion engine that performs compression combustion, the internal combustion engine control apparatus comprising:
an injection command unit that commands the fuel injection apparatus to perform a main injection for a main combustion that generates torque and a preceding injection that is performed at a stage before the main injection; and
an injection specification determining unit that determines a penetration force of a spray produced by the preceding injection or an injection direction of the preceding injection, such that a range of reach of the spray produced by the preceding injection is closer to a nozzle hole of the fuel injection apparatus than a range of reach of a spray produced by the main injection.

2. The internal combustion engine control apparatus according to claim 1, wherein:
the preceding injection is performed at a compression stroke.

3. The internal combustion engine control apparatus according to claim 1, wherein:
the injection specification determining unit reduces the penetration force of the spray produced by the preceding injection compared to the penetration force of the spray produced by the main injection by reducing either or both of an injection pressure and a nozzle hole diameter of the preceding injection compared to that of the main injection, and sets the range of reach of the spray produced by the preceding injection closer to the nozzle hole of the fuel injection apparatus compared to the range of reach of the spray produced by the main injection.

4. The internal combustion engine control apparatus according to claim 1, wherein:
the injection specification determining unit sets the range of reach of the spray produced by the preceding injection closer to the nozzle hole of the fuel injection apparatus than the range of reach of the spray produced by the main injection by facing an injection direction of the preceding injection further towards a partition wall of the combustion chamber than that of the main injection.

5. The internal combustion engine control apparatus according to claim 1, further comprising:
an information acquiring unit that acquires information related to a state quantity and a fuel property of the combustion chamber; and
an ignition timing determining unit that determines an injection timing of the preceding injection based on the state quantity and the fuel property such that a timing at which radicals are generated by a low-temperature oxidation reaction of the spray produced by the preceding injection coincides with an injection timing of the main injection.

6. The internal combustion engine control apparatus according to claim 5, wherein:
the injection timing determining unit delays the injection timing of the preceding injection as a temperature inside the combustion chamber, which serves as a state quantity, increases and advances the injection timing of the preceding injection as the temperature inside the combustion chamber decreases.

7. The internal combustion engine control apparatus according to claim 5, wherein:
the injection timing determining unit delays the injection timing of the preceding injection as an octane number of the fuel, which serves as the fuel property, decreases and advances the injection timing of the preceding injection as the octane number of the fuel increases.

8. The internal combustion engine control apparatus according to claim 5, wherein:
the injection specification determining unit reduces the penetration force of the spray produced by the preceding injection as the injection timing of the preceding injection is advanced, and increases the penetration force of the spray produced by the preceding injection as the injection timing of the preceding injection is delayed.

9. The internal combustion engine according to claim 5, wherein:
the injection specification determining unit faces the injection direction of the preceding injection further towards the partition wall of the combustion chamber as the injection timing of the preceding injection is advanced, and faces the injection direction of the preceding injection further away from the partition wall of the combustion chamber as the injection timing of the preceding injection is delayed.

10. The internal combustion engine control apparatus according to claim 1, further comprising:
if a total of an injection amount of the preceding injection and an injection amount of the main injection is referred to as a total injection amount, and a proportion of the injection amount of the preceding injection in relation to the total injection amount is referred to as a preceding injection proportion,
an information acquiring unit that acquires information related to a load of the internal combustion engine; and
an injection amount determining unit that increases the preceding injection proportion as the load of the internal combustion engine decreases, and reduces the preceding injection proportion as the load of the internal combustion engine increases.

11. The internal combustion engine control apparatus according to claim 1, further comprising:
if a total of an injection amount of the preceding injection and an injection amount of the main injection is referred to as a total injection amount, and a proportion of the injection amount of the preceding injection in relation to the total injection amount is referred to as a preceding injection proportion,
an information acquiring unit that acquires information related to a state quantity and a fuel property of the combustion chamber; and
an injection amount determining unit that determines the preceding injection proportion based on the state quantity and the fuel property such that a timing at which radicals are generated by a low-temperature oxidation reaction of the spray produced by the preceding injection coincides with an injection timing of the main injection.

12. The internal combustion engine control apparatus according to claim 11, wherein:
the injection specification determining unit reduces the preceding injection proportion as the temperature inside the combustion chamber, which serves as the state quantity, increases and increases the preceding injection proportion as the temperature inside the combustion chamber decreases.

13. The internal combustion engine control apparatus according to claim 11, wherein:
the injection specification determining unit reduces the preceding injection proportion as the octane number of the fuel, which serves as the fuel property, decreases and increases the preceding injection proportion as the octane number of the fuel increases.

14. An internal combustion engine control system that controls operation of an internal combustion engine by a combustion method in which fuel contained in air is auto-ignited and combusted, the internal combustion engine control system comprising:
at least one added substance supply apparatus that supplies an added substance that generates radicals in an intake passage or a combustion chamber; and
a supply control unit that controls a supply amount of the added substance, wherein
the added substance includes at least a substance that generates radicals at a temperature equal to or higher than 700 kelvins.

15. The internal combustion engine control system according to claim 14, further comprising:
a hydrogen peroxide supply apparatus that supplies hydrogen peroxide that generates hydroxyl radicals in the intake passage or the combustion chamber at a temperature equal to or higher than 700 kelvins, as the added substance supply apparatus.

16. The internal combustion engine control system according to claim 15, wherein:
the supply control unit increases a hydrogen peroxide supply amount as a combustion chamber internal temperature decreases or an operating load of the internal combustion engine decreases.

17. The internal combustion engine control system according to claim 15, wherein:
the hydrogen peroxide supply apparatus includes
a water introducing unit that introduces water into the intake passage, and
an ultrasonic wave irradiation apparatus that irradiates ultrasonic waves onto the water introduced into the intake passage by the water introducing unit to generate hydrogen peroxide.

18. The internal combustion engine control system according to claim 15, wherein:
an exhaust gas recirculation passage through which a portion of exhaust gas is recirculated to the intake passage is provided; and
the hydrogen peroxide supply apparatus includes an ultrasonic wave irradiation apparatus that irradiates ultrasonic waves onto moisture contained in the exhaust gas that is recirculated through the exhaust gas recirculation passage and generating hydrogen peroxide.

19. The internal combustion engine control system according to claim 15, wherein:
the supply control unit increases the hydrogen peroxide supply amount as an amount of unburned hydrocarbon or soot emission contained in the exhaust gas increases.

20. The internal combustion engine control system according to claim 15, further comprising:
an ozone supply apparatus that supplies ozone that generates oxygen radicals in the intake passage or the combustion chamber, as the added substance supply apparatus, wherein
the supply control unit supplies both hydrogen peroxide and ozone at at least a portion of a range of the combustion chamber internal temperature or the operating load of the internal combustion engine.

21. The internal combustion engine control system according to claim 20, wherein:
an exhaust gas recirculation passage through which a portion of exhaust gas is recirculated to the intake passage is provided; and
the ozone supply apparatus also functions as a hydrogen peroxide supply apparatus that irradiates ultrasonic waves onto moisture in the exhaust gas that is recirculated through the exhaust gas recirculation passage and generating hydrogen peroxide.

22. The internal combustion engine control system according to claim 20, wherein:
the supply control unit increases the supply amount of at least either of hydrogen peroxide and ozone as the combustion chamber internal temperature decreases or the operating load of the internal combustion engine decreases.

23. The internal combustion engine control system according to claim 20, wherein:
the supply control unit increases the supply amount of at least either of hydrogen peroxide and ozone as the amount of unburned hydrocarbon or soot emission in the exhaust gas increases.

24. The internal combustion engine control system according to claim 20, wherein:
the supply control unit increases a ratio of the hydrogen peroxide supply amount to the oxygen supply amount as the combustion chamber internal temperature increases.

25. The internal combustion engine control system according to claim 20, wherein:
the internal combustion engine control system switches between a diffusive combustion mode in which fuel is injected into compressed air and combusted, and a premixing auto-ignition combustion mode in which a pre-mixture of fuel and air is compressed, auto-ignited, and combusted; and
the supply control unit supplies only hydrogen peroxide or increases the ratio of the hydrogen peroxide supply amount to the ozone supply amount in the diffusive combustion mode, and supplies only ozone or reduces the ratio of the hydrogen peroxide supply amount to the ozone supply amount in the premixing auto-ignition combustion mode.

26. The internal combustion engine control system according to claim 25, wherein:
the supply control unit supplies both ozone and hydrogen peroxide during a mode transition period in which switching between the diffusive combustion mode and the premixing auto-ignition combustion mode is performed.

27. The internal combustion engine control system according to claim 14, wherein:
the supply control unit acquires a temperature detected by a temperature sensor provided inside the combustion chamber as the combustion chamber internal temperature.

28. The internal combustion engine control system according to claim 14, wherein:
the supply control unit estimates the combustion chamber internal temperature based on an intake-air temperature detected by a temperature sensor provided in the intake passage.
